(19) United States
(12) Patent Application Publication
(10) Pub. No.: US 2021/0396705 A1
(43) Pub. Date: Dec. 23, 2021

(54) MICROFLUIDIC RESPIROMETRY OF METABOLIC FUNCTIONS IN BIOLOGICAL SAMPLES

(71) Applicant: Board of Trustees of Michigan State University, East Lansing, MI (US)

(72) Inventors: Denis A. PROSHLYAKOV, East Lansing, MI (US); Julia V. BUSIK, East Lansing, MI (US)

(73) Assignee: Board of Trustees of Michigan State University, East Lansing, MI (US)

(21) Appl. No.: 17/350,094

(22) Filed: Jun. 17, 2021

Related U.S. Application Data
(60) Provisional application No. 63/040,059, filed on Jun. 17, 2020.

(51) Int. Cl. G01N 27/327; B33Y 80/00; B01L 3/00

(52) U.S. Cl. CPC G01N 27/3276; B33Y 80/00; G01N 27/3277; B01L 2300/0645; B01L 2300/0654; B01L 2200/027; B01L 3/502715

(57) ABSTRACT

A clinical or research instrument or apparatus is provided. In another aspect, an apparatus operably conducts microfluidic measurement of metabolic functions in biological samples. A further aspect employs an instrument which includes an enclosed sample chamber having walls of low oxygen permeability and an optically transparent material to allow remote probing or sensing of oxygen.

### CROSS-REFERENCE TO RELATED APPLICATIONS

This application claims the benefit of U.S. Provisional Application Ser. No. 63/040,059, filed on Jun. 17, 2020, which is incorporated by reference herein.

### GOVERNMENT RIGHTS

This invention was made with government support under GM096132, under EY016077, and under EY028049 awarded by the National Institutes of Health. The government has certain rights in the invention.

### BACKGROUND AND SUMMARY

The present disclosure generally pertains to an apparatus for use with biological samples and more particularly to an apparatus for microfluidic measurement of metabolic functions in biological samples.

Oxidation is the most common method of transducing hydrocarbons into energy. Aerobic organisms oxidize molecules in a stepwise manner while synthesizing adenosine triphosphate (“ATP”), the energy currency of the cell. Mitochondria are specialized organelles where oxidation is coupled to phosphorylation by capturing the energy of electron transport, via a chain of proteins to O₂, to create a proton gradient across an inner mitochondrial membrane, which then fuels phosphorylation of adenosine diphosphate (“ADP”). In other words, ADP phosphorylation is the addition of a phosphate group to ADP thereby converting it into ATP.

The rate of oxygen consumption, the final step of the mitochondrial electron transport chain, provides information about the activity of electron transport chain protein complexes, transporters and ATP synthase. Two major approaches, polarographic or fluorescence quenching, are used for the measurement of O₂ concentration in solution, which provide the necessary data for calculation of oxygen consumption rates. Traditional sophisticated titration protocols, using varying substrate and inhibitor combinations, were developed to glean information about specific segments of the oxidative phosphorylation machinery. Tremendous progress has been made in understanding mitochondrial function using these approaches. There are, however, several limitations of currently available methodology. Conventional polarographic measurements are based on the current produced by reduction of O₂ on an electrode, such that oxygen consumption by the sample must be significantly higher than that on the electrode, dictating an undesirably high tissue demand of this approach. Traditional fluorescence quenching methods do not impose this demand, however they undesirably utilize open configurations that require compensation for ingress of atmospheric oxygen due to diffusion. It is also a concern that both conventional polarographic and fluorescence quenching measurements have been performed with static samples that only allow for cumulative, non-reversible titration protocols. The polarographic approach is commercially known as the Clark oxygen electrode such as sold by Oroboros Instruments Corp. The fluorescence quenching approach can be commercially obtained as the Seahorse XF analyzer from Agilent Technologies, Inc.

Furthermore, a prior experiment employing an enclosed flow-through cell respirometer is disclosed in M. Jekabsons and D. Nicholls, “In Situ Respiration and Bioenergetic Status of Mitochondria in Primary Cerebellar Granule Neuronal Cultures Exposed Continuously to Glutamate,” Journal of Biological Chemistry (Jul. 30, 2004), vol. 279, no. 31, at 32989-33000. This experiment used oxygen electrodes to determine pre- and post-sample differentials in oxygen tension, monitored respiration of primary cerebellar granule neuron cultures, and determined ATP supply and demand, proton leak, and mitochondrial respiratory capacity during chronic glutamate exposure. This approach, however, undesirably required complex custom assembly, does not accumulate a signal if sample activity is low, and was not amenable to automation and scaling up for high-throughput measurements.

In accordance with the present invention, a clinical or research instrument or apparatus is provided. In another aspect, an apparatus operably conducts microfluidic measurement of metabolic functions in biological samples. A further aspect employs an instrument which includes an enclosed sample chamber having walls of low oxygen permeability and an optically transparent material to allow remote probing or sensing of oxygen. Yet another aspect employs a microfluidic respirator instrument which includes a transparent wall, a sensor and a continuous fluid flow path through a biological specimen area during sensing. A tandem microfluidic respirometer simultaneously tracks both a reduction of mediators on an electrode and an ensuing reduction of O₂ in the biological specimen, in still another aspect of the present apparatus and method. A method of performing microfluidic respirometry of metabolic functions in biological samples is additionally provided.

The present apparatus and method are advantageous over traditional devices. For example, the present instrument allows for a reduction of sample volume by 10-1000 fold as compared to the typical sample volume waste encountered in conventional approaches. Furthermore, the present instrument beneficially exhibits low oxygen permeability which reduces or eliminates atmospheric interference; for example, the measurements may be conducted at low PO₂. The optically transparent wall of the present instrument allows for remote probing or sensing of oxygen using sensory chromophores. Moreover, the composition or volume of solution flowing through the present instrument can be changed or supplemented at any time during the process, as contrasted to traditional static and fixed solution volumes which create baseline testing control issues if the solution is changed.

The present apparatus and method also allow for an easy washing action due to a cleaning fluid flowing between the use of different chemical solutions, through the specimen chamber. It is also advantageous that the present instrument can use either adherent (i.e., adherent cells, immobilized organelles or organisms) or non-adherent (i.e., suspension cells, organelles or organisms) specimens in the chamber. Therefore, certain aspects of the present apparatus and method uses a microliter sample size, small sized device, and a disposable sensor cartridge with raw (uncorrected) sensitivity exceeding prior methodologies, and at a fraction of the initial capital and operation costs. The present system can advantageously obtain a measurement within three minutes if sample activity is high or in excess of fifteen minutes if the same activity is low. Additional advantages and features of the present apparatus and method can be ascertained from the following description and appended claims, taken in conjunction with the accompanying drawings.

### BRIEF DESCRIPTION OF THE DRAWINGS

FIG. 1 is a diagrammatic illustration showing the present microfluidic respirator instrument, acting upon a specimen;

FIG. 2 is an exploded and partially fragmentary, top perspective view showing a first embodiment of the present microfluidic respirator instrument;

FIG. 3 is an exploded and partially fragmentary, bottom perspective view showing the first embodiment of the present microfluidic respirator instrument;

FIG. 4 is an assembled and partially fragmentary, bottom perspective view showing the first embodiment of the present microfluidic respirator instrument;

FIG. 5 is a cross-sectional view, taken along line 5-5 of FIG. 4, showing the first embodiment of the present microfluidic respirator instrument;

FIG. 6 is a cross-sectional view, taken along line 6-6 of FIG. 5, showing the first embodiment of the present microfluidic respirator instrument;

FIG. 7 is a diagrammatic, cross-sectional view, taken through the specimen chamber, showing the first embodiment of the present microfluidic respirator instrument;

FIG. 8 is a diagrammatic, cross-sectional view, taken through the specimen chamber along line 8-8 of FIG. 7, showing the first embodiment of the present microfluidic respirator instrument;

FIG. 9 is a side elevational view showing the first embodiment of the present microfluidic respirator instrument;

FIG. 10 is a cross-sectional view, taken along line 10-10 of FIG. 9, showing the first embodiment of the present microfluidic respirator instrument;

FIG. 11 is a diagrammatic, cross-sectional view, taken through the specimen chamber, similar to that of FIG. 8, showing a second embodiment of the present microfluidic respirator instrument;

FIG. 12 is a diagrammatic, cross-sectional view, taken through the specimen chamber, similar to that of FIG. 8, showing a third embodiment of the present microfluidic respirator instrument;

FIG. 13 is a partially exploded, top perspective view showing the third embodiment of the present microfluidic respirator instrument;

FIG. 14 is a partially exploded, bottom perspective view showing the third embodiment of the present microfluidic respirator instrument;

FIG. 15 is a diagrammatic, cross-sectional view, taken through the specimen chamber, showing a fourth embodiment of the present microfluidic respirator instrument, indicating an initial specimen adhesion condition;

FIG. 16 is a diagrammatic, cross-sectional view, taken through the specimen chamber, showing the fourth embodiment of the present microfluidic respirator instrument, indicating an intermediate assembly condition;

FIG. 17 is a diagrammatic, cross-sectional view, taken through the specimen chamber, showing the fourth embodiment of the present microfluidic respirator instrument, in a fully assembled and measurement condition;

FIG. 18 is a partially exploded, bottom perspective view showing the fourth embodiment of the present microfluidic respirator instrument;

FIG. 19 is a partially exploded, top perspective view showing the fourth embodiment of the present microfluidic respirator instrument;

FIG. 20 is a partially fragmented, top perspective view showing the fourth embodiment of the present microfluidic respirator instrument;

FIG. 21 is a cross-sectional view, taken along line 21-21 of FIG. 20, showing the fourth embodiment of the present microfluidic respirator instrument;

FIG. 22 is a bottom perspective view showing a manifold employed in a fifth embodiment of the present microfluidic respirator instrument;

FIG. 23 is a partially exploded top perspective view showing the fifth embodiment of the present microfluidic respirator instrument;

FIGS. 24 and 25 are fragmentary perspective views showing counter-electrodes employed in the fifth embodiment of the present microfluidic respirator instrument;

FIG. 26 is a top perspective view showing a microfluidic chip of the fifth embodiment of the present microfluidic respirator instrument;

FIG. 27 is a partially exploded bottom perspective view showing the fifth embodiment of the present microfluidic respirator instrument;

FIG. 28 is a cross-sectional view, taken along line 28-28 in FIG. 26, showing the chip employed in the fifth embodiment of the present microfluidic respirator instrument;

FIG. 29 is a bottom perspective view showing the chip of the fifth embodiment of the present microfluidic respirator instrument;

FIG. 30 is a cross-sectional view, taken along line 30-30 in FIG. 23, showing the chip employed in the fifth embodiment of the present microfluidic respirator instrument;

FIG. 31 is an electrical schematic diagram of the fifth embodiment of the present microfluidic respirator instrument;

FIGS. 32 and 33 are graphs showing a comparison of expected results from chemical and electrochemical control of mitochondrial respiration related to the fifth embodiment of the present microfluidic respirator instrument;

FIGS. 34-36 are graphs showing expected simultaneous measurements of charge transfer and oxygen reduction in microfluidic electrochemical related to the fifth embodiment of the present microfluidic respirator instrument;

FIGS. 37-39 are graphs showing expected results for electrochemically supported respiration in mitochondrial suspension related to the fifth embodiment of the present microfluidic respirator instrument;

FIG. 40 is a graph showing an expected ratiometric assessment of intrinsic activity of COX in an inner mitochondrial membrane related to the fifth embodiment of the present microfluidic respirator instrument;

FIG. 41 is a graph showing an expected correlation between oxygen consumption rates simultaneously determined from a transferred charge and fluorescence quenching, related to the fifth embodiment of the present microfluidic respirator instrument;

FIG. 42 is a diagram showing mass transfer schematics of mediated mitochondrial electrochemistry related to the fifth embodiment of the present microfluidic respirator instrument; and

FIG. 43 is a graph showing an expected correlation of mitochondrial oxygen consumption rates observed upon chemical and electrochemical reduction at various TMPD concentrations, related to the fifth embodiment of the present microfluidic respirator instrument.

### DETAILED DESCRIPTION

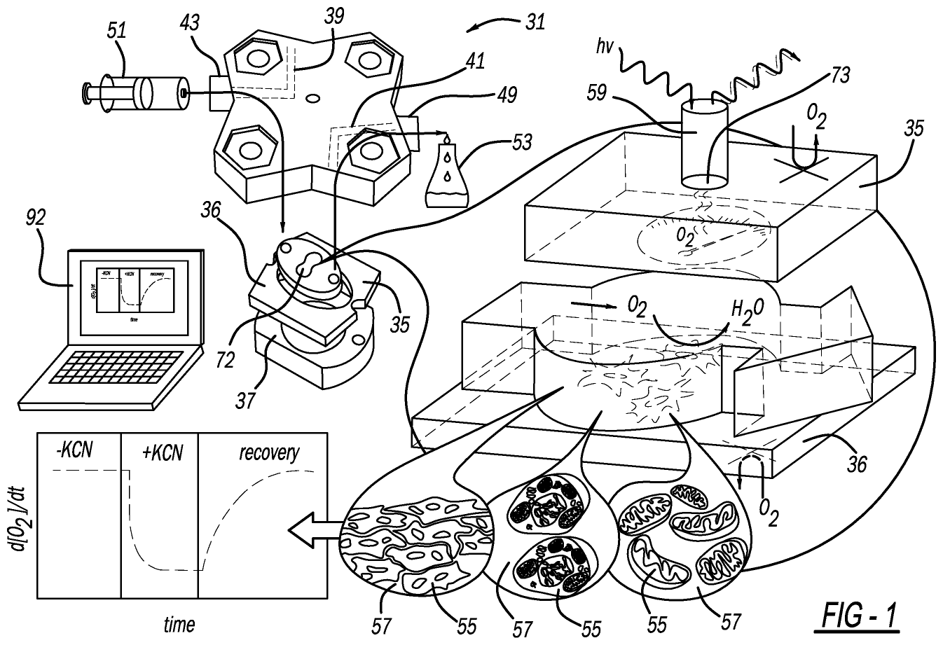

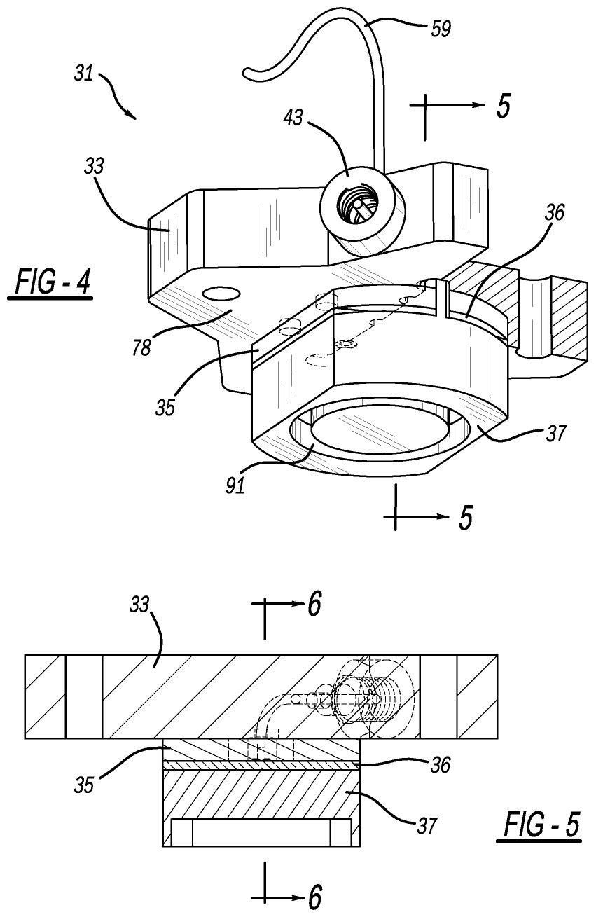

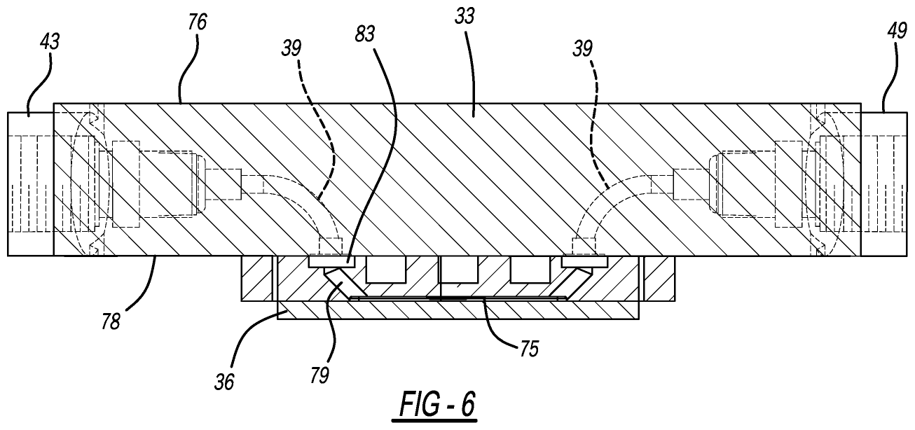

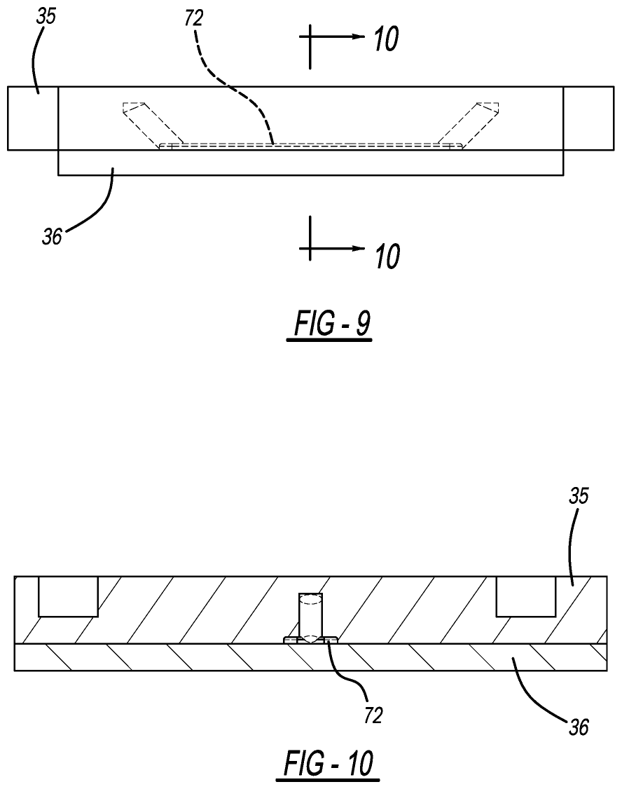

A first exemplary embodiment of a microfluidic respirator instrument 31 is shown in FIGS. 1-10. This version of instrument 31 allows for a continuous flow of a chemical solution and includes a manifold 33, a sensing chip or housing 35, a plate 36, and a compression base 37. Manifold 33 includes internal fluid passageways 39 and 41 between their respective inlet ports 43 and 47, and their respective outlet ports 45 and 49. A syringe 51 is removably connectable to inlet port 43 for insertion of a chemical solution 57, while a beaker 53 or other container is removably connected to outlet port 49 to receive the specimen or chemical solution. Alternately, a conduit instead of a syringe can be attached to the inlet port via a threaded fitting. Optical fibers 59 extend through a longitudinally extending, central aperture 71 in manifold and a sensor patch or optode 73, coupled to distal ends of optical fibers 59 is located within or adjacent to a channel 75 running along a bottom surface 77 of housing 35. More specifically, optode 73 is in direct contact with the solution and there is only a thin transparent wall separating optical fibers 59 from channel 75. A programmable computer 92 is connected to optical fibers 59 for controlling LED light emissions down one of the fibers and for receiving sensor signals back from another of the fibers from patch 73. The computer can then automatically or manually determine characteristics sensed from the specimen and display the results on its output display screen. A chamber or area 69 for holding a biological specimen 55 is defined between channel 75 of housing 35 and the opposite flat upper surface 72 of base 37.

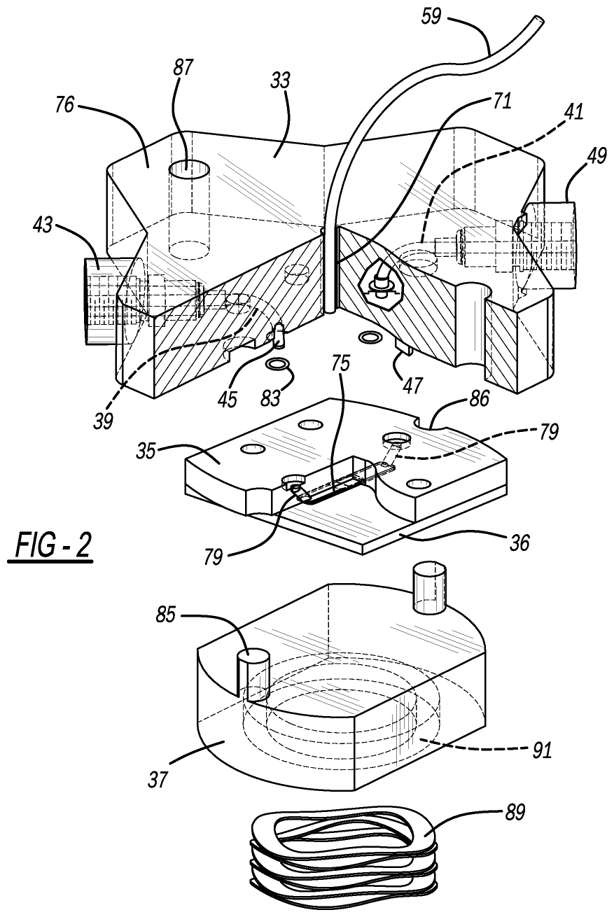

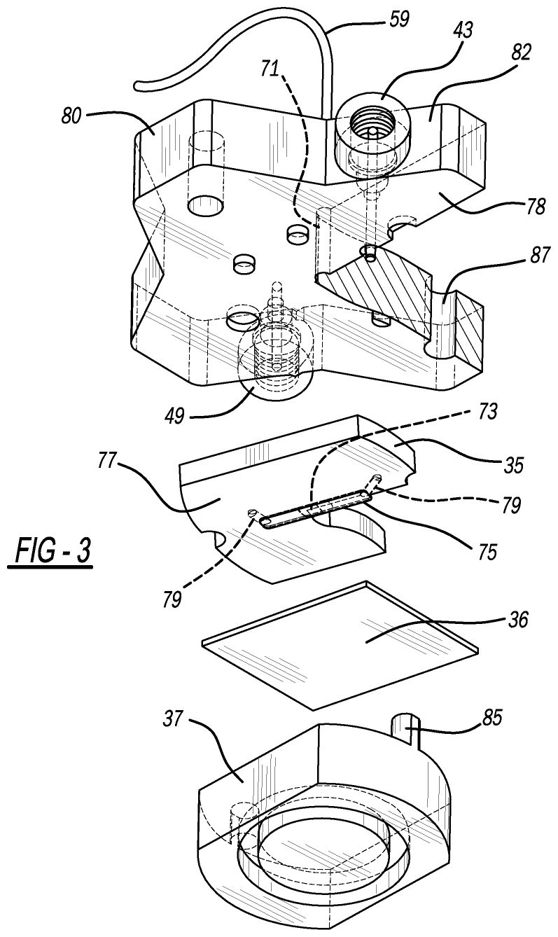

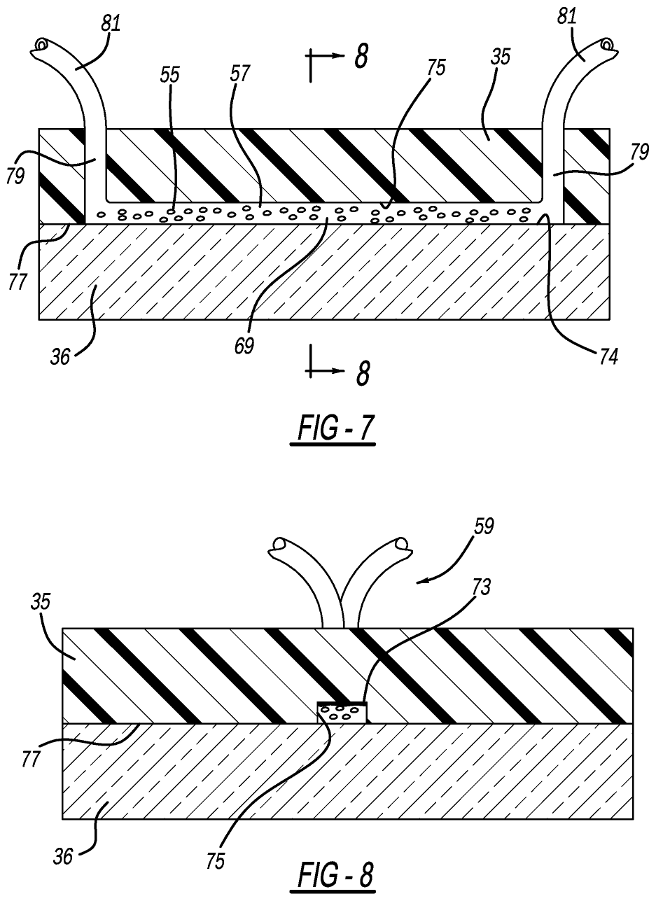

Manifold 33 has generally flat and parallel top and bottom planar surfaces 76 and 78, respectively joined by a generally star shaped peripheral edge 80 with diagonal flats 82 from which extend cylindrical ports 43 and 49. It should be appreciated that any surface on the entire manifold may have an alternate shape. Either integrally formed passageways 79 (see FIGS. 2 and 3) in housing 35 and/or projecting tubular passageways 81 (see FIG. 7) couple lateral ends of channel 75 to the bottom outlet and inlet ports 45 and 47, respectively, of manifold 33 to allow specimen and/or solution flow therebetween. O-rings 83 are located between passageways 79 in the housing and ports 45 and 47 of the manifold.

Plate 36 is adhesively bonded onto housing 35. In one example, a Loctite® EA E-30CL epoxy mixture is thinned and applied along a perimeter of the microchannel, ensuring no spillover into the channel. The housing is spun at approximately 2100 rpm for about 20 seconds and the solvent evaporates for about 5 minutes at room temperature. The glass plate is first cleaned in acetone and then applied to the housing and cured overnight under mechanical pressure. Furthermore, a stacked wave disk spring 89 is held within an arcuate and closed shape groove 91 of base 37 to create a “floating” or adjustable alignment of contact surfaces of the chip and the manifold, while uniformly compressing together the components without causing pressure points. Alignment rods 85 longitudinally projecting from opposite areas of base 37 are received within slots 86 of housing 35 and holes 87 of manifold 33 to provide coarse alignment. Then multiple small pins of the manifold provide the final fine alignment of the housing, plate and base. Subsequently, the entire assembly is longitudinally retained together with threaded bolt and nut fasteners extending through holes in the manifold and the base. The present embodiment is a closed shell configuration for suspension samples or specimens 55.

Manifold 33, housing 35 and base 37 are preferably three-dimensionally printed in VeroClear brand polymethylmethacrylate-like, transparent resin which can be obtained from Objet Geometries Inc. Other transparent and non-oxygen permeable (i.e., 02 impermeable), polymeric materials, such as polycarbonate and/or other manufacturing processes, such as injection molding or lost wax casting, may be employed for the manifold, housing and/or base. Plate 36 is preferably a sheet of transparent glass. The transparent nature of housing 35 and plate 36 advantageously has optically transmissive properties for coupling to fiber optics 59 and/or patch 73. The preferred materials are also well suited for chemical cleaning and sterilization.

Channel 75 is preferably 2.0 mm wide by 0.15 mm deep and is ideally created by the three-dimensional printing since the rounded nature of the melted polymeric beads, applied during the additive layering, creates smoother surfaces without edges or roughness, as contrasted to mechanical micro-machining or other such traditional material removal techniques. The rounded and smoother channel surfaces beneficially avoid bubbles or other turbulent fluid flow issues, while also avoiding contaminants hiding in surface irregularities and corners during cleaning. Bottom surface 77 containing channel 75 is upwardly oriented on the bed of the printing machine to prevent support material deposition into the channel. Furthermore, glass-contacting surfaces of the housing is cleaned and subsequently polished with an approximately 5 μm grit silicon carbide sheet after optode deposition to improve flatness.

The O₂ optode or patch 73 is deposited by casting or spin coating. For drop casting, a ˜220 mg/mL stock solution of PS in bromobenzene or chloroform is prepared at room temperature. By way of one fluorophore example and not limitation, the working PS/PtOEP solution is a 1:4 (v/v) dilution of PS stock with a 2 mg/mL solution of PtOEP in the same solvent. One microliter of the PS/PtOEP mixture is deposited into a center of channel 75 and dried under a stream of warm air, having a temperature of <50° C. For spin coating, PtOEP (˜1 mg/mL) and 12.5-25% (m/m) PS in bromobenzene or chloroform solution is applied to housing 35 followed by spinning at approximately 1000 rpm for about 2 minutes; any remaining solvent is removed under reduced pressure of about 0.2 bar.

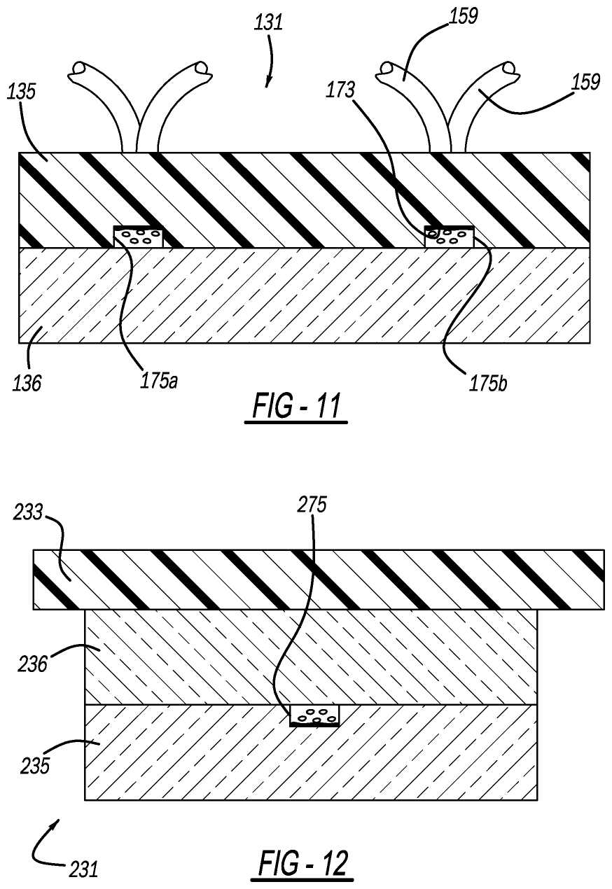

FIG. 11 shows a second embodiment of a microfluidic respirator instrument 131. Instrument 131 includes a manifold, a sensing chip or housing 135, a plate 136, and a compression base. This version is similar to the previous one except that the present housing 135 include multiple channels 175a and 175b which are laterally elongated parallel to each other. Multiple sets of corresponding passageways in the manifold will correspond to channels 175a and 175b, either from different inlet and outlet ports, or branching from common inlet and outlet ports. If different ports, then different chemical solutions may simultaneously flow through the different channels but within the previously identically created specimen, which removes a variable from the test. Input and output optical fibers 159 and a patch or optode 173 are associated with each channel.

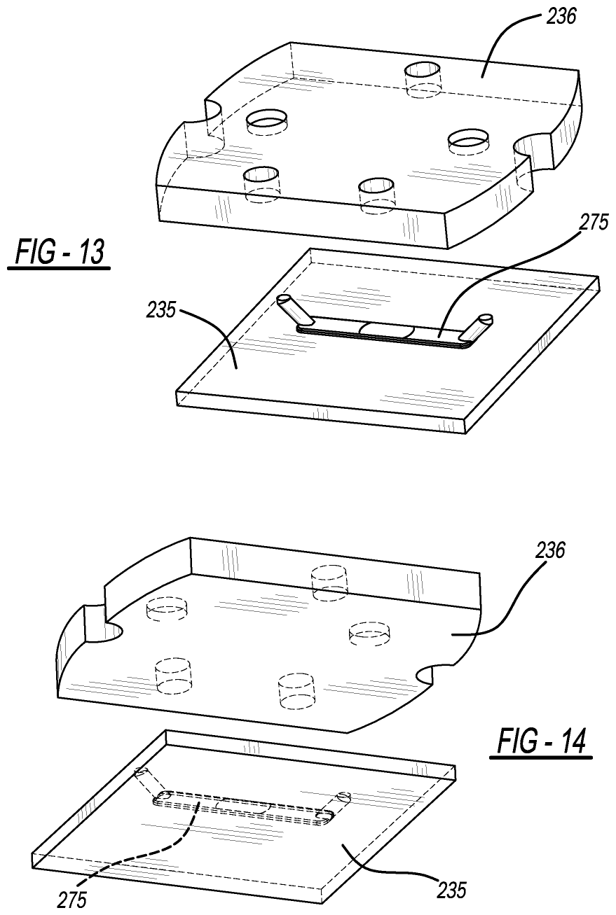

FIGS. 12-14 illustrate a third embodiment of a microfluidic respirator instrument 231. Instrument 231 includes a manifold 233, a sensing chip or housing 235, a plate 236, and a compression base. This version is similar to the first embodiment except that the present housing 235 and plate 236 are reversed, such that a specimen chamber within a laterally elongated channel 275 is closer to the base with plate 236 between the housing and manifold 233. In one example, channel 275 is etched into housing 235 with the inlet and outlet passageways and/or capillaries created in plate 236. In another example, plate 236 may optionally be additively printed or molded from a polymeric material to provide integral fluid passageways or if plate 236 is glass, simple holes can be cut therein with o-ring seals between it and the manifold ports and between it and the ends of channel 275. Alternately, as a further example, plate 236 may be integrally formed as part of manifold 233.

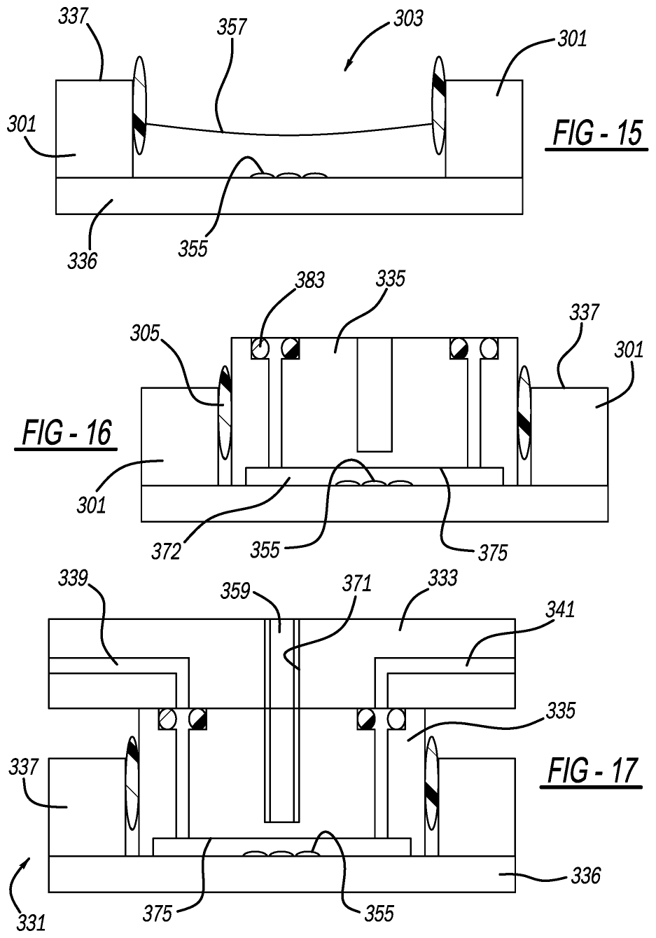

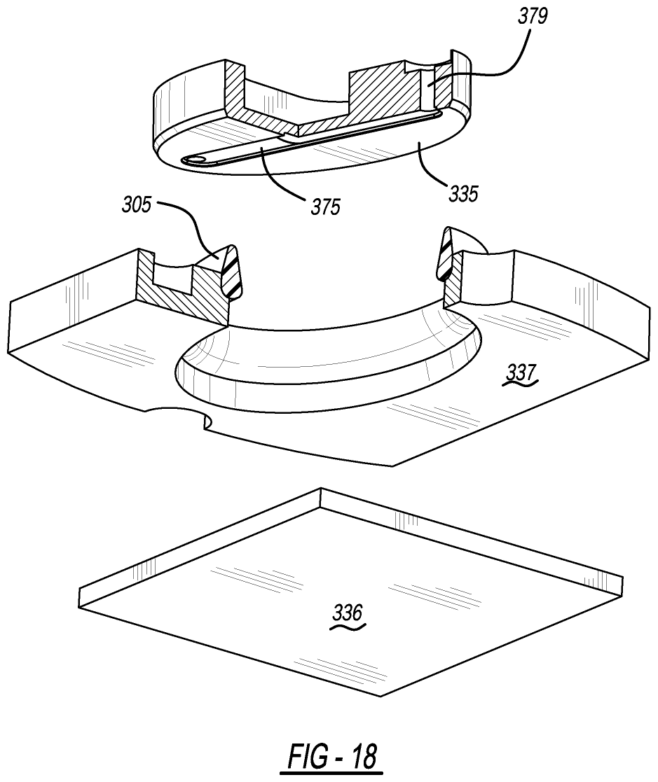

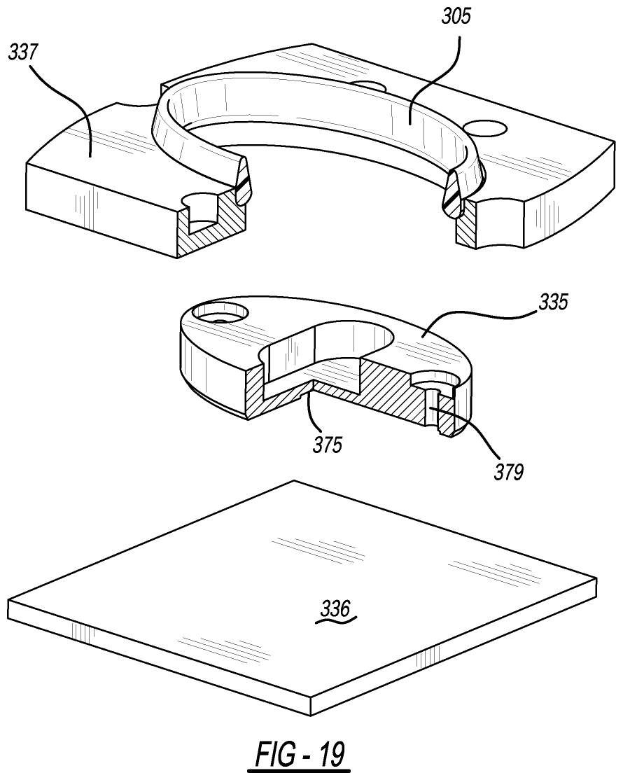

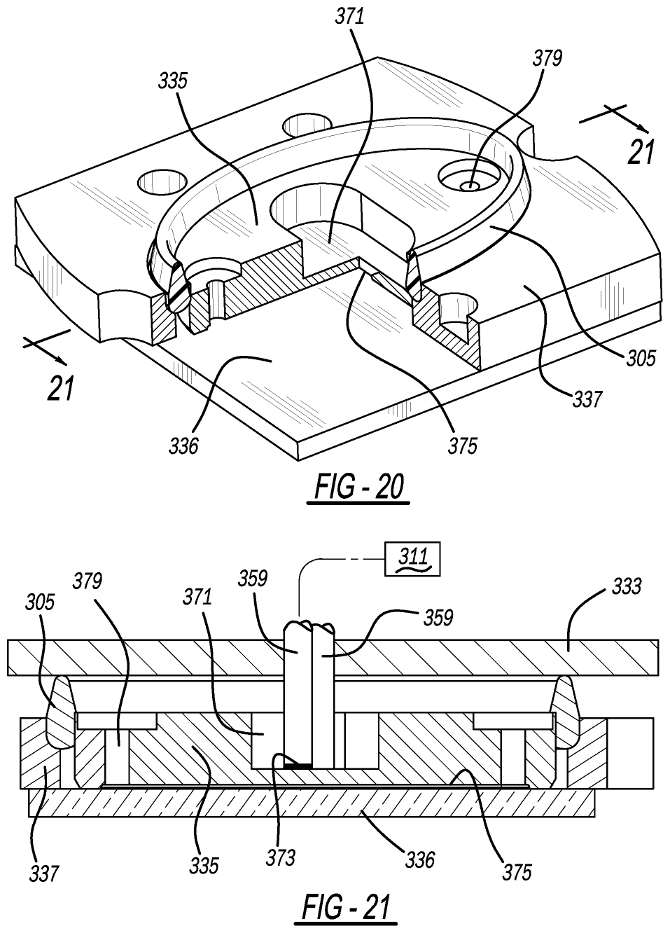

An open-shell configuration can be observed in FIGS. 15-21. FIGS. 15-17 specifically illustrate the use of a microfluidic respirator instrument 331 for adherent samples or specimens 355. This embodiment of instrument 331 includes a manifold 333, a sensing chip or housing 335, a plate 336, and a base 337. Base 337 is adhesively mounted onto an upper flat surface of glass plate 336. Specimen cells 355 are first cultured within liquid media or solution 357 on glass plate 336 bordered by retention walls 301 of base 337 (which is differently shaped and positioned than the base of the previous embodiments), to create a well 303 which is open to the incubator atmosphere. This is a specimen adhesion step. Second, housing 335 is placed into the well on top of plate 336 and between walls 301 with a tear-drop cross-sectionally shaped, three-way seal 305 therebetween. A laterally elongated channel 375 spans along a center of the ovular shaped bottom surface of housing 335 and defines specimen chamber 372 between it and the adjacent flat surface of plate 336. Housing 335 is removably mounted to base 337 through an interference fit of seal 305 compressing between an outer edge of the housing and the facing inner edge of the base, such that housing 335 is in removable sealing engagement with underlying plate 336 due to it being bonded to base 337. Optionally, adhesive may bond the housing to the plate if removability is not desired. Thereafter, manifold 333 is mounted onto housing 335 with O-ring seals 383 between housing passageways 379 and ports in the manifold. Alignment pins and threaded fasteners may also be employed to align and removably secure the base to the manifold like with the first embodiment. These are the intermediate and final assembly steps. The final assembly step is also referred to as a measurement step which includes the sequential application of a sensor patch 373, located within a cavity 375 defining chamber 372, and associated with the bundled together and preassembled fiber optic excitation and emission fibers 359, immediately prior to R_{O2} determination. The housing, manifold and base are preferably three-dimensionally printed from a polymeric material, preferably optically transparent for the housing.

The measurements are based on reversible quenching of luminescence intensity and decay time of an optode, being an oxygen-sensitive fluorophore cast in a polymeric matrix (such as Polystyrene), by oxygen modelled by a Stern-Volmer equation. The measurements are performed using a phase-shift fluorimeter 311. Fluorescence emission of optode 373 is collected by an optical fiber 359 through the housing cavity wall and conducted to fluorometer 311 for fluorescensce lifetime analysis.

With regard to all of the instrument embodiments herein, O₂-impermeable, additively manufactured polymer is preferably used to make the channel within which is the specimen chamber. Optical transparency of the housing and thus, channel, allows the instrument to sample an oxygen-sensitive fluorescence-based thin film deposited on the inner surface of the channel without exposing the sample to atmospheric O₂. Accordingly, adherent cells can be cultured directly on-chip and sampled over prolonged periods of time using repetitive and reversible stimulation of a given sample for observation of metabolic response, using a closed chip with at least an intermittent flow of cell medium to replenish oxygen and nutrients. In addition to adherent cells, an experimental protocol can be adapted to isolated mitochondria and cell suspensions. Ease of production, flexibility in protocol design, and direct quantitative reporting of O₂ consumption rates make this system highly amenable to both precise individual measurements and parallelization as needed for drug discovery and testing.

Furthermore, the present instrument embodiments are sensitive and customizable method of measuring O₂ consumption rates by a variety of biological samples in microliter volumes without interference from the aerobic environment. O₂ permeability of the photopolymer, such as the exemplary VeroClear™ material, is comparable to that of polyetheretherketone (0.125 vs. 0.143 barrier, respectively) providing an efficient barrier to oxygen ingress. Optical transparency of the channel material, combined with high resolution three-dimensional printing of the channel, allows for optode-based oxygen detection in enclosed samples. These properties yield a micro-respirometer with over 100× dynamic range for O₂ consumption rates. It is noteworthy that the enclosed respirometer configurations and very low oxygen permeability of materials makes it suitable, with resin pre-conditioning, for quantitative assessment of O₂ consumption rates at any desired O₂, including hyperbaric, physiological or hypoxic conditions as necessary for each cell type. The present instrument embodiments are ideally suited to study soluble enzymes, isolated mitochondria, cells in suspension, and adherent cells cultured on-chip. Improved sensitivity allows for routine quantitative detection of respiration by as few as several hundred cells. Moreover, adherent cell protocols allowed for physiologically relevant assessment of respiration in retinal pigment epithelial cells, ARPE-19, which displayed lower metabolic rates compared with those in suspension. By exchanging medium composition, cells can be transiently inhibited by cyanide and that 99.6% of basal O₂ uptake is recovered upon its removal.

Measurements on cell suspensions are expected to achieve high sensitivity with the present instrument, detecting R_{O2} in as few as several hundred cells. This represents three orders of magnitude higher sensitivity than conventional large volume respirometers, and approximately 10 times the sensitivity of traditional plate-based respirometry. Such sensitivities are afforded by the small volumes, tight control over O₂ ingress, and short distances between the optode and respiring cells in the present instrument. Suspension measurements should have minimal gain from increasing cell density as higher absolute R_{O2} is offset by decreased reproducibility.

Sensitivity of adherent cell measurements is proportional to surface cell density and inversely proportional to the channel depth, but is independent of channel width or length, assuming a uniform cell monolayer and sensor width greater than channel depth. Therefore, reduction in channel depth is beneficial until shear stress and O₂ ingress become liming factors. An optimal depth for the channels 75, 175, 275 and 375 is 70-150 μm because shear stress scales linearly with flow rate and as the inverse square of the channel height. Further reduction of height would necessitate large reductions in flow rates to control shear of adherent cells. Therefore, the increased cell aggregation would negatively affect reproducibility in suspension measurements.

The interrupted-flow approach in the adherent microfluidic respirometer configuration enables development of novel measurement strategies. First, cell samples are kept at the desired O₂ (near saturation) because cellular R_{O2} is measured for a short period before medium replenishment. This allows the microfluidic respirometer to sustain prolonged experiments without inducing metabolic changes associated with hypoxic responses. Furthermore, continuous buffer exchange can mimic classical titration-based protocols and is further amenable to addition and removal of metabolic stimuli to study reversibility of metabolic switches.

Isolation of the sample from the atmospheric environment is particularly desirable for micro-respirometry due to the high surface area to volume ratios inherent in microfluidics. In contrast, with conventional regimes, surface exchange of O₂ can lead to relatively rapid changes in bulk O₂ concentrations in the medium. Ingress of atmospheric O₂ into conventional microchannel can adversely affect results, decreasing instrument sensitivities and causing non-linear responses due to the accumulation of concentration gradients and diffusion according to Fick's Law. The non-linearity of steady-state R_{O2} is particularly problematic for multi-phasic processes, such as in the transition from ADP-dependent to ADP-limited respiratory states of isolated mitochondria. For example, ADP-limited respiration in conventional devices has been under-estimated when samples reach lower O₂, affecting calculated parameters such as respiratory control and ADP:O ratios.

The present microfluidics-based respirometry instrument and method is well suited for studies on biological energy transduction. Taking advantage of remote sensing in an isolated microchannel, this simple, yet versatile, apparatus and method can detect O₂ consumption by minute amounts of sample, ranging from soluble enzyme systems to cell or organelle suspensions and adherent samples. This should perform well in the context of eukaryotic respiration, although it can be employed for measurements of bacterial and plant metabolism. A combination of low oxygen permeability with flexible configuration allow for direct, uncompensated data acquisition, which is also amenable for automation. The present instrument includes at least one sensor continuously sensing an oxygen-independent, electrochemical assay while targeting components of electron transport chains while keeping specimen samples catalytically active for at least two days in the specimen chamber.

### Tandem Electrochemistry and Respirometry Instrument Embodiment:

A fifth embodiment will now be discussed that allows electrochemical manipulation of a sample with optional simultaneous O₂ measurement by tandem electrochemistry and respirometry. More specifically, a tandem microfluidic respirometer simultaneously tracks both a reduction of mediators on an electrode and an ensuing reduction of O₂. The response time of O₂ consumption to multiple alternating potential steps is of approximately 10 s for a 150 μm thick sample. Furthermore, steady O₂ depletion shows good quantitative correlation with the supplied electric charge, such that Pearson's r=0.994 (FIG. 41). Reduction of mediators on electrodes can compete with the oxidation of mediators by mitochondria, yielding overall respiratory activity comparable to that upon chemical reduction by ascorbate. The dependence of O₂ consumption on mediator and mitochondrial suspension concentrations shows that mass transport between the electrode and mitochondria does not limit biological activity of the latter. Moreover, the present mediated electrochemical approach is validated by radiometric measurements of simulated changes in the intrinsic mitochondrial activity upon partial inhibition of Complex IV by NaN₃. This approach enables the development of O₂-independent, biomimetic electrochemical assays narrowly targeting components of the electron transport chains in their native environments.

Assessment of activities of mitochondrial electron transport enzymes is desired for understanding mechanisms of metabolic diseases, but structural organization of mitochondria and low sample availability pose distinctive challenges in traditional situ functional studies, in addition to intrinsic limitations of existing conventional respirometric techniques that use either polarography or fluorescence quenching to measure O₂ consumption as a net probe of metabolic activity. While multiple combinations of substrates and inhibitors have been developed to evaluate changes in individual complexes of mitochondrial electron transport chain (“ETC”), such conventional protocols still sample total electron flow to cytochrome c oxidase (“COX”) along a complex redox chain, complicating interpretation.

This analysis is further compounded by low permeability of the inner mitochondrial membrane (“IMM”), whose integrity is needed for preserving chemiosmotic gradient and control over ETC; only a few native substrates can cross the IMM without disrupting it. There is also growing evidence that native supramolecular interactions are desired for optimal ETC function. Therefore, any sample manipulations that can disturb native mitochondrial organization, including alterations of the outer mitochondrial membrane (“OMM”), should be minimized. Thus, there is a need for the present instrument and method that can yield quantitative, complex-specific information about mitochondrial function that would lead to insights into the role of mitochondrial dysfunction in chronic diseases.

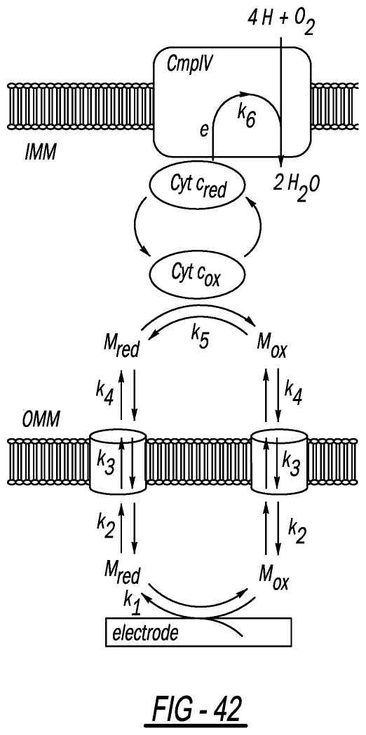

The intrinsically electrochemical nature of the ETC makes mitochondria unique eukaryotic organelles. The present instrument and method allow for some, or all, of the ETC steps to be supported from an electrode without the use of consumable chemical substrates. Accordingly, the present approach has multiple advantages over traditional chemical titrations, including differential sampling, ease of quantification, unlimited electron supply, testing of maximal activity of individual ETC sections, scalability, and remote manipulations. It is noteworthy, however, that spatial separation imposed by the OMM effectively precludes direct electron transfer between the electrode and the ETC. Removal of the OMM to form a mitoplast allows to measure activity of COX following oxidation of cytochrome c (“CytC”), for example, but this disrupts native mitochondrial compartmentalization and is undesirable. Small mediator molecules are used instead to shuttle electrons between the electrode and the ETC, as can be viewed in FIG. 42. Accordingly, an ideal reversible redox mediator should freely cross the OMM, without partitioning into the lipid bilayer, and be selective for or native to a specific ETC complex. If the net electrochemical current via such mediator is controlled by its redox partner ETC complex(s), it can be used to extract direct information about said partner.

To achieve this, the electrochemical method causes an overall rate limiting step, including mass transport of the mediator, to be a function of the ETC enzyme(s) of interest. Every mitochondrion in a microfluidic suspension is accessible to the mediator(s) within the diffusion limit of the electrode, while reducing sample demand and improving integrity with shorter preparation time. Also, the present large electrode area per sample volume also ensures adequate heterogeneous catalytic capacity to sustain unrestricted respiration needed for detecting changes in COX activity.

Accordingly, the present microfluidic mediated electrochemical approach is used for functional testing of ETC enzymes. Various examples of the present instrument and method focus on the activity of COX in mitochondrial suspensions as the most suitable target for direct comparison with traditional polarography. Using simultaneous respirometric and amperometric analysis of O₂ reduction, quantitative measurement of changes in COX activity using electric current in lieu of O₂ consumption are demonstrated and comparisons are made of respirometric and electrochemical detection methods using artificial mediators.

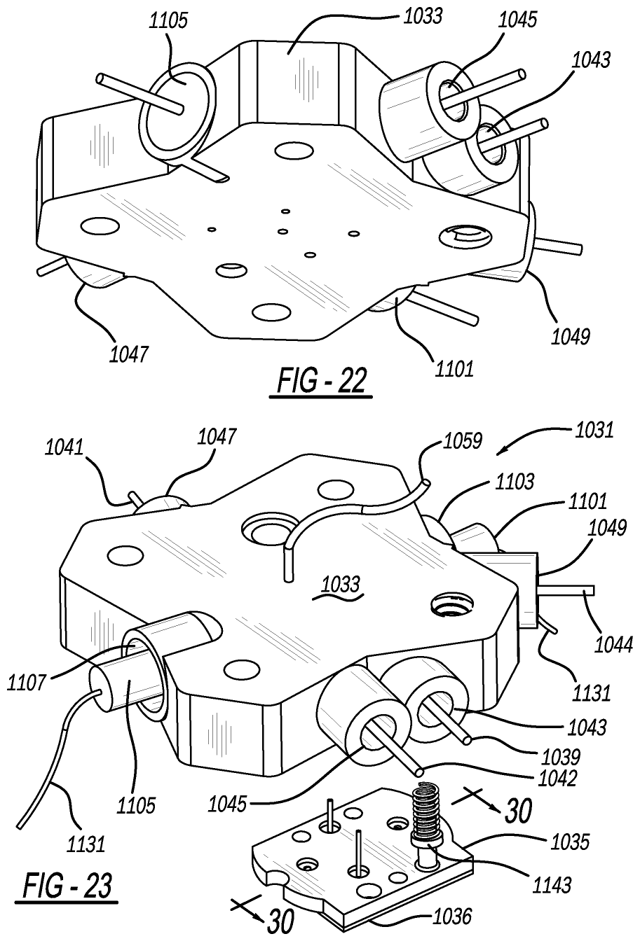

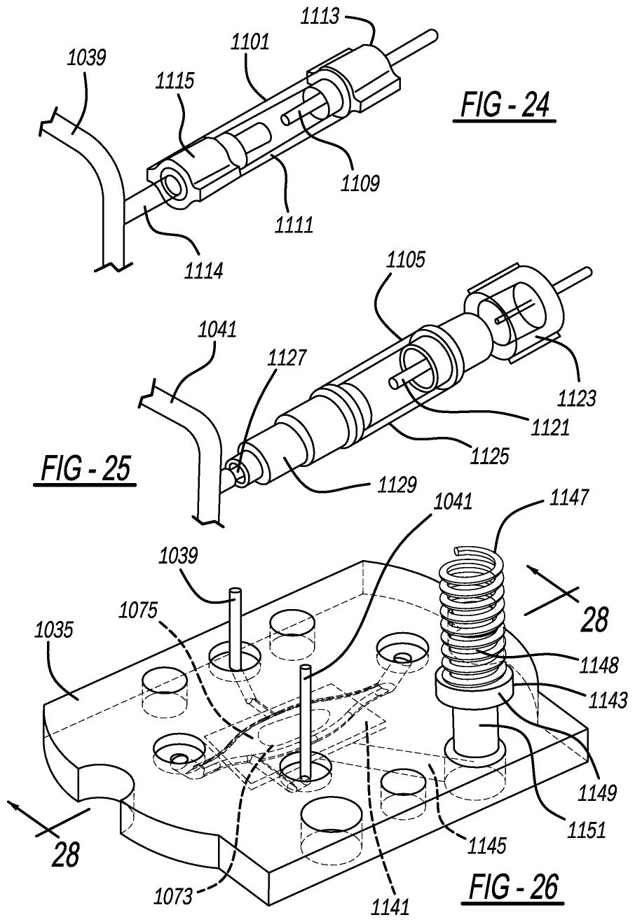

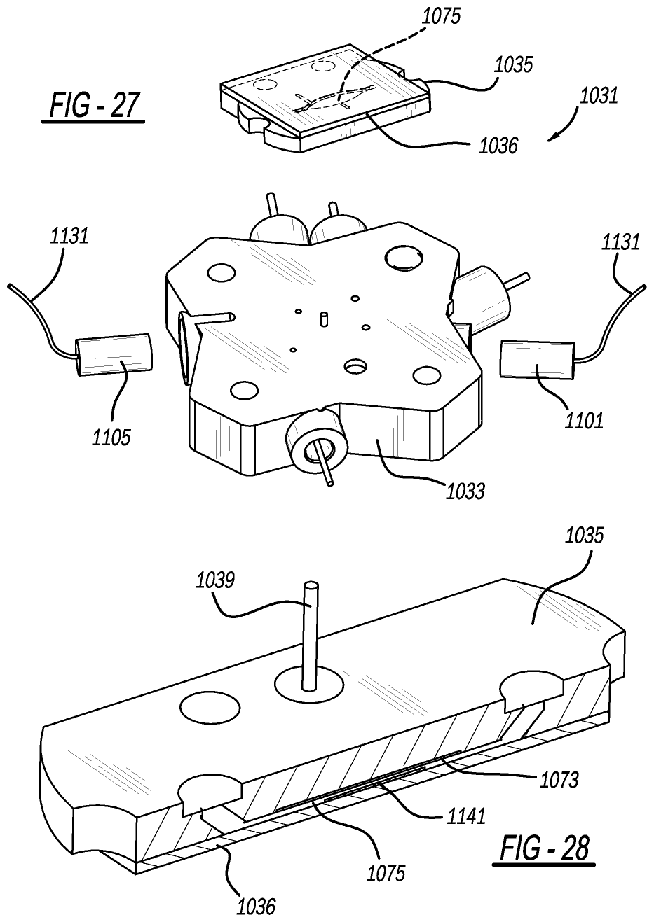

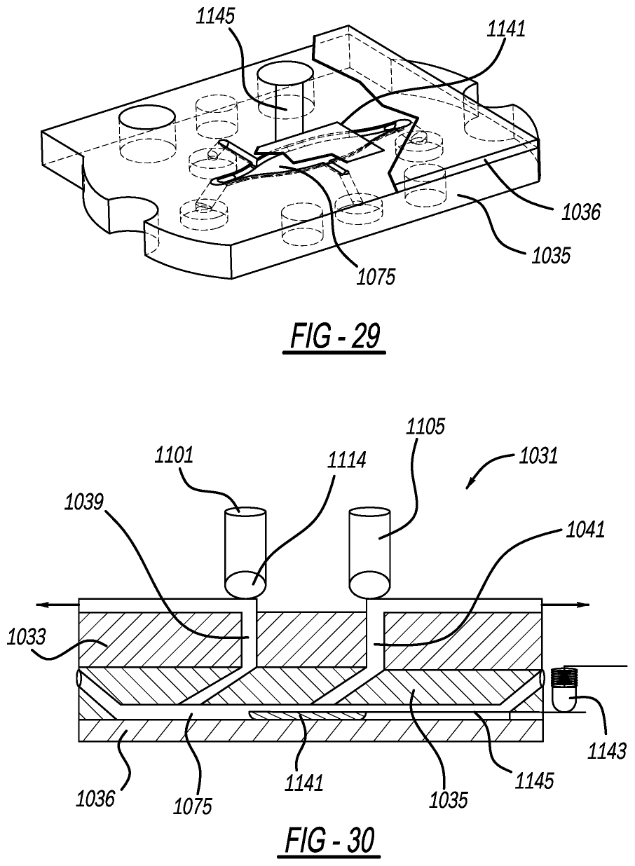

More specifically, the present fifth exemplary embodiment of a microfluidic respirator instrument 1031 is shown in FIGS. 22-31. This version of instrument 1031 allows for a continuous flow of a chemical solution and includes a manifold 1033, a sensing chip or housing 1035 and a plate 1036. Manifold 1033 includes internal fluid passageways 1039 and 1041 to their respective sample inlet/outlet ports 1043 and 1047, and internal fluid passageways 1042 and 1044 are associated with their respective outlet ports 1045 and 1049 to exit waste electrolyte solution. A syringe, supply tube or the like is connectable to the inlet ports for insertion of a chemical solution, while a beaker, collection tube or other container is removably connected to the outlet ports to receive the specimen or chemical solution. The plugs may be removably capped after sample and solution insertion in some uses of the instrument.

Optical fibers 1059 (for the FIG. 23 version) extend through a longitudinally extending, central aperture in the manifold and a sensor patch or optode 1073, coupled to distal ends of optical fibers 1059 is located within or adjacent to a channel 1075 running along a bottom surface of housing 1035. More specifically, optode 1073 is in direct contact with the solution and there is only a thin transparent wall separating optical fibers 1059 from channel 1075. A programmable computer 1092 is connected to optical fibers 1059 for controlling LED light emissions down one of the fibers and for receiving sensor signals back from another of the fibers from patch 1073. The computer can then automatically or manually determine characteristics sensed from the specimen and display the results on its output display screen.

Additionally, a counter electrode 1101 is located within a port 1103 and a reference electrode 1105 is located with a port 1107 of manifold 1033. Alternately, any of the electrodes referenced herein may be placed remotely away from the manifold but still be coupled to a passageway internal or external to the manifold and/or chip. Counter electrode 1101 includes a carbon lead electrically conductive wire 1109 centrally within a surrounding cylindrical body 1111 and a proximal end cap 1113. Furthermore, counter electrode 1101 includes a sol-gel plug 1114 centrally extending through a distal end cap 1115. Sol-gel plug 1114 acts as a barrier in keeping the solution separate from outlet capillary passageway 1039 but allows ion movement therethrough; this creates a generally Y-shaped three-way junction with subchambers in passageway 1039 being connected by the intervening plug at the junction point.

Reference electrode 1105 includes an oxidized silver wire 1121, as a nonlimiting example, centrally extending through a proximal end cap 1123. Wire 1121 is concentrically disposed inside a cylindrical body 1125. Moreover, a platinum wire 1127 centrally extends through and projects from a distal end cap 1129 to act as a Y-junction barrier within waste capillary passageway 1041 in a similar manner as with the counter electrode.

Electrodes 1101 and 1105 act as oppositely polarized anode or cathode set depending on the desired electrical polarization as controlled by programmable computer controller 1092. Controller 1092 is connected to electrodes 1101 and 1105 via an electrical circuit 1131. Controller 1092 includes a microprocessor, memory, an input keyboard and an output display screen. An exemplary controller and circuit can be obtained from CH Instruments, Inc. as the model 600E series electrochemical analyzer.

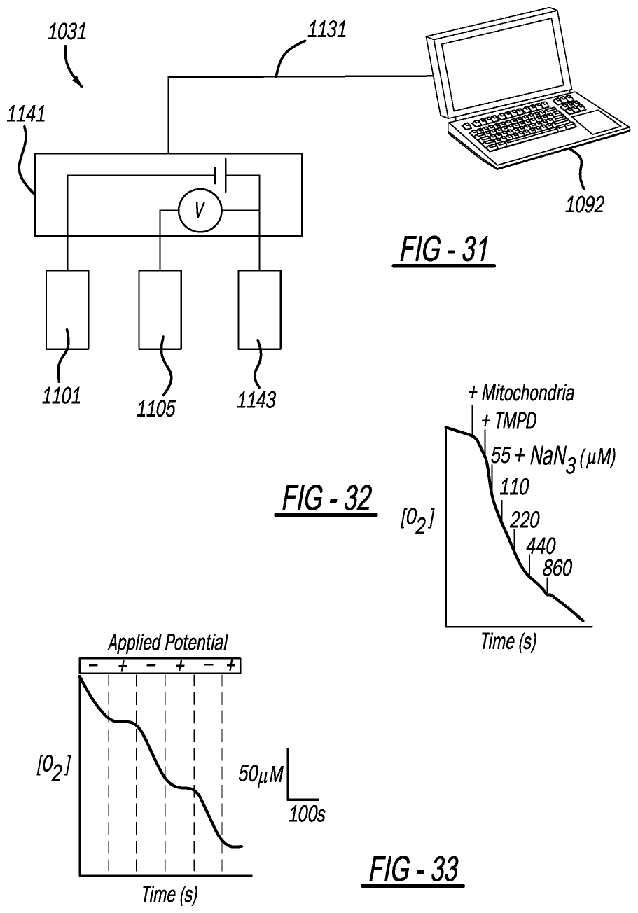

A working electrode 1141 is located in a bottom segment of specimen chamber 1075 against plate 1036. Working electrode 1141 is electrically connected to a potentiostat 1144 (see FIG. 31) via an electrical conductor 1145 and a connector pin 1143. Connector pin 1143 includes a generally t-shaped rigid post 1145 with a compression spring 1147 surrounding an upper arm 1148 of the post above a laterally enlarged shoulder 1149. A lower leg 1151 of the post is mounted to housing 1025 and electrically connected to conductor 1145. Post 1145 is electrically connected to potentiostat 1144 and controller 1092 through circuit 1131.

Both counter and reference capillaries extended past the corresponding electrode assembly to the separate sealable ports, allow air bubbles to be flushed from the capillary passageways with a supporting electrolyte. The counter electrode preferably employs a carbon rod partially submerged in an electrolyte solution, located in a sealed compartment, with its dry end connected to the potentiostat. A short section of an ion-permeable partition separates the counter electrode and the capillary leading to the chip, such as a tetramethyl-orthosilicate (TMOS) sol-gel cast in a 2.7 mm diameter polyethylene tubing. The sol-gel-filled tubing is cut to size with a blade and stored in a solution of the electrolyte and a desired pH buffer, until use. The sol-gel partition in the manifold is always kept wet.

The reference electrode is preferably saturated KCI Ag/AgCl and prepared by the oxidation of Ag wire in 1M HCl. The reference electrode compartment is partitioned from the associated microfluidic capillary passageway by a Pt wire assembled in the manifold by a compressing o-ring with a matching internal diameter. Such a wire separates the reference electrode and the capillary leading to the chip. Reference electrode is tested periodically by cyclic voltammetry (CV) of 1 mM Fe(CN)₆^{-3/-4} or another reference analyte under standard electrochemical conditions and regenerated as necessary.

### EXAMPLE

The microfluidic chamber (chip), including the O₂-sensitive optode, is shown in FIGS. 22 and 23 as a modification of the first embodiment to accommodate the electrodes. The working electrode 1141 is connected to manifold 1033 via a dry pin or post 1149 contact. Reference and counter electrodes 1105 and 1101 are assembled entirely in the manifold and connected to the chip via the separate sealed capillaries. Alternatively, reference and counter electrodes can be located outside of and remotely coupled to the manifold as long as continuity of the passageways filed with electrolyte solution is ensured. Wire 1109 is 1.3 mm diameter graphite or carbon, and tetramethyl-orthosilicate sol-gel plug 1114 is used to prevent mass transfer between the counter electrode compartment and a working solution while ensuring ionic continuity. All results are reported versus saturated KCI Ag/AgCl reference electrode 1105. Advantageously, the present manifold with the imbedded electrodes are all useable for over a year period which provides excellent durability.

The manufacturing of an exemplary working electrode 1141 will now be discussed in greater detail, appreciating that alternate electrode materials can be employed. Glass substrate or plate 1036 is coated with 40 nm Au (which may be obtained from Research and PVD Materials) over 5 nm Ti by chemical vapor deposition (“CVD”). Geometry of the Au electrode is created photolithographically using positive S1813 photoresist prior to CVD and the bare Au electrodes are modified to prevent biological fouling. The Au/carbon ink composite electrodes (AuCi) are prepared by spin-coating a 2 g/ml mixture of carbon ink (obtained from Ercon Inc.) in Ercon ET60 solvent thinner over Au at 1200 rpm for 30 s. The electrodes are dried at 75° C. and then at 120° C. for 60 min each. Next, the AuCi is activated in the assembled chamber immediately before every proposed experiment by a potential of +2 V over 120 s in 50 mM potassium phosphate buffer, pH 7.0. With regular cleaning, the AuCi chips can be used with mitochondrial samples, repeatedly for over 30 days without noticeable degradation of performance.

Modification of Au with fumed silica (AuFs) is performed prior to the assembly of the microfluidic chamber as described, and all of the AuFs electrodes are stored in MilliQ water. Moreover, glassy carbon (“GC”) electrodes are freshly polished using 1 μm MicroPolish alumina powder three times, rinsed with MilliQ water and dried before each use. Again, alternate electrode materials may be used.

Electrochemical measurements may be performed using CHI830C potentiostat 1143. Electrode characterizations may also be performed using CVs of Fe(CN)₆^{-3/-4} and Ru(NH₃)₆^{-3/-4} in 0.5 M KCl in a three-electrode cell with carbon rod counter electrode and a standard saturated KCl Ag/AgCl reference electrode. An electrochemically active surface area of the electrode is determined from a Randles-Sevcik equation at varying scan rates and the reported diffusion coefficients of Fe(CN)₆^{-3/-4} and Ru(NH₃)₆^{-3/-4}. Measurements in a fully assembled microfluidic chip are carried out under static conditions after sample injection using a syringe (˜400 μL) or a pipet (<50 μL). The chip is thoroughly rinsed between measurements using a water-50% ethanol in water-water sequence.

Simultaneous respirometric and chronoamperometric measurements start with an open circuit potential (no applied potential) followed by the applied potential alternating between 0.35V and −0.15V for oxidizing and reducing conditions, respectively. An additional oxidizing step at the end of the measurement is used to calculate background O₂ concentration changes.

Mitochondrial measurements may be performed in 10 mM Tris-HCl, pH 7.5, containing 125 mM KCl, 1 mM EGTA, and 100 mM potassium phosphate. Exogenous CytC may be added to the final concentration of 25 μM when using previously frozen mitochondrial samples as a precaution for possible permeabilization of the OMM during isolation and freezing to improve sample uniformity and to ensure efficient electron transfer from TMPD to COX. Addition of CytC to freshly isolated samples may not be necessary. No additional treatments of IMM or OMM are performed.

During polarographic measurements, autoxidation OCR in the presence of Na ascorbate and CytC are measured separately for varying TMPD concentrations. Linear interpolation to the average 02 concentration is subsequently used to determine autoxidation OCR during each mitochondrial measurement. Autoxidation rates in microfluidic conditions are measured using control samples containing TMPD and CytC immediately before corresponding mitochondrial measurements. Since both measurements start at 250 μM O₂, interpolation of autoxidation OCRs is not performed.

Traditional polarographic respirometry involves sequential additions of substrates, uncouplers, or inhibitors to large (1-3 ml) enclosed volumes of mitochondrial suspensions. Such additions are cumulative and cannot be reversed, as illustrated in FIG. 32 for TMPD, to facilitate reduction of CytC by ascorbate, and the titration with NaN₃, to inhibit COX. Measurements in the presence of excess inhibitor (NaN₃ or KCN) probe background 02 consumption and should be performed as the last step.

Electrochemical control over mitochondrial respiration is illustrated in FIG. 33, where TMPD is reduced on the electrode and oxidized by COX via CytC. Oxidized TMPD is re-reduced on the electrode in contrast to FIG. 32, where it is reduced by the ascorbate. Furthermore, a small thickness of microfluidic sample ensures fascicle access of TMPD to the electrode and limits sample volume. Only 0.34 μg of mitochondrial protein is used in the microfluidic chamber in FIG. 33, which is three orders of magnitude less than the 0.35 mg of used in the polarographic measurement of FIG. 32.

Unlike reactions with chemical reductants, the present electron transfer on the electrode can be controlled by the applied potential and result in reversible reduction or oxidation of TMPD. This, in turn, controls TMPD-supported O₂ reduction by COX and correlates with changes in the O₂ consumption rates (“OCR”) between negative and positive potential steps, as can be observed in FIG. 33. A short delay, observed between the potential step and the ensuing OCR response, is attributed to the propagation of the changes in redox states between the electrode and the optode.

More specifically, FIG. 32 shows a Clark electrode measurement of mitochondrial suspension in a ˜2 mL chamber in the presence of 8 mM sodium ascorbate. Sequential additions of 1 mM TMPD and indicated concentrations of NaN₃ are shown. Meanwhile, FIG. 33 illustrates an electrochemical measurement in a ˜3.6 μL microfluidic chamber in the presence of 1 mM TMPD. Reduction and oxidation of TMPD is controlled by alternating −150 mV reducing (−) and +350 mV oxidizing (+) potential. The expected data are shown on the identical scales, and the protein concentrations are 0.175 mg/mL and 0.094 mg/mL for FIGS. 32 and 33, respectively.

Expected results shown in FIG. 33 suggest that OCR can be assessed by either following changes in the O₂ concentration or from the charge supplied from the electrode. Quantitative correlation between electric charge and the electrochemically induced O₂ depletion (optode OCR) are examined using a simplified chemical model of the following equation (1):

O₂+4H⁺+4e⁻→2 H₂O

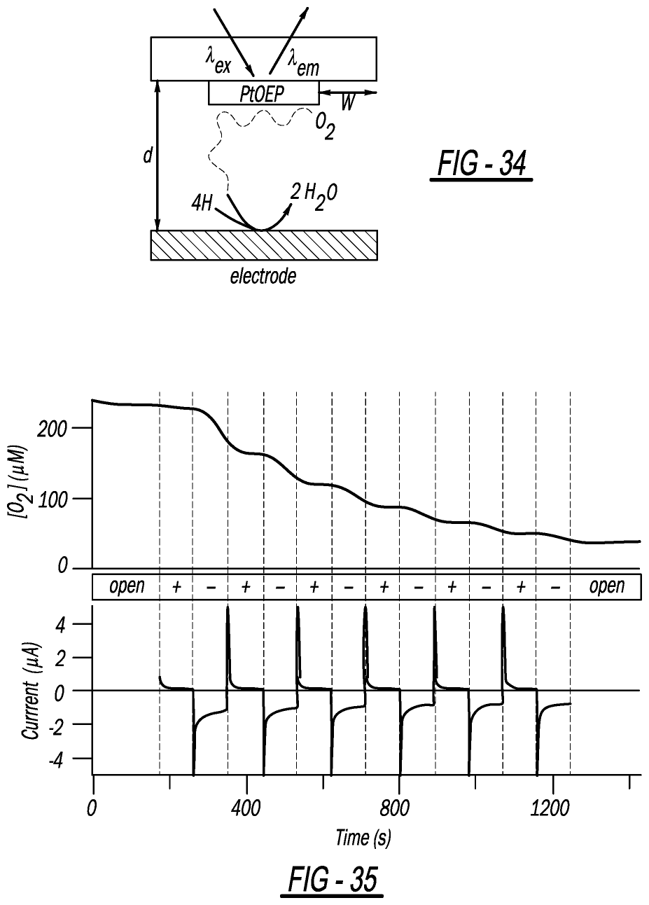

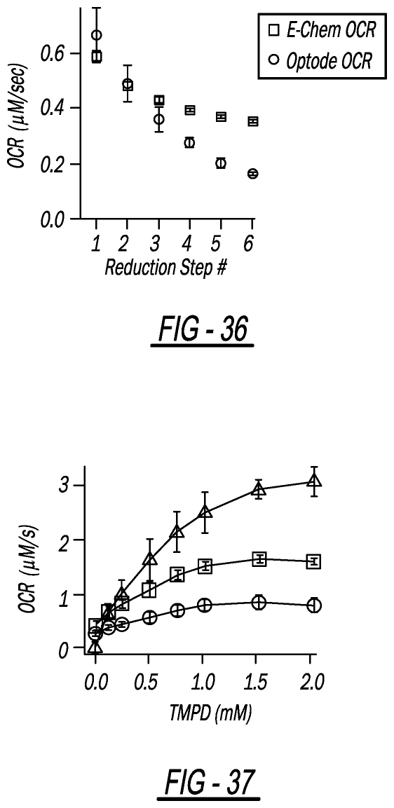

FIGS. 34-36 illustrate expected simultaneous measurement of charge transfer and oxygen reduction in the microfluidic electrochemistry. FIG. 34 shows a schematic of the cross-section of the microfluidic chamber with layer thickness d while O₂ reduction on the electrode is detected by the Pt-OEP optode upon its depletion on the opposite side. FIG. 35 shows an expected tandem measurement of O₂ concentration and the simultaneously measured amperogram under alternating potentials. Open circuit (open), 350 mV (+), and −450 mV (−) potentials are applied as shown in the central bar, while applied potentials are held constant for the duration of steps shown by vertical lines. Referring to FIG. 36, expected OCR is reported by the O₂ optode (open circles) and equivalent electric charge (filled squares), with measurements being performed in 0.1 M HCl, 0.5 M KCl on the AuCi electrode.

It is noteworthy that detection of the electric charge and the changes in O₂ concentration take place at the opposite walls of the chamber, which represents the worst-case scenario for the diffusion of the analyte across a sample of thickness d=125 μm (FIG. 34). No significant change in the O₂ concentration is reported by the optode (FIG. 35, top) under an open potential and during initial oxidizing potential step (+350 mV). Furthermore, a simultaneously recorded amperogram shows a minimal oxidation current after initial surface charging (FIG. 35, bottom). However, a subsequent decrease in the applied potential (−450 mV) results in a steady depletion of O₂ from the solution with simultaneously detected sustained anodic current. Both processes continued until the reversal of the applied potential during the second cycle. Such a pseudo-respiration pattern, which mimics mitochondrial results, shown in FIG. 33, will be observed over multiple alternating cycles.

The differential optode OCR is calculated from the slope of O₂ concentration over time during the reduction step against the average of such slopes during two flanking oxidation steps. Similar correction of the electric current is not necessary since the oxidation current is small relative to the reduction current. The total electric charge for each reduction step is converted into electrochemical OCR using the chamber design volume and the equivalent amount of consumed O₂. The OCR values to be obtained using two methods should be in good agreement with each other, especially at the beginning of the measurement, referencing FIG. 36, and exhibits similar decrease over successive cycles, as expected with net O₂ depletion. Two detection methods show linear correlation with Pearson's r=0.994, as can be seen in FIG. 41. The average relative standard deviations over six steps are ±9.6% and ±2.3% for the OCRs measured simultaneously using optode or amperometric detection, respectively.

It is noted that the optode reported increasingly negative OCR during oxidation steps as O₂ gradients increase over successive cycles. At the same time, electrode OCR and the average optode O₂ concentration exhibit evidence of saturation, resulting in the correlation slope of 0.456±0.024 when the transferred charge is converted into amount of consumed O₂ per Eq. 1, again referring to FIG. 41. The rebound of O₂ concentration during oxidation steps is most noticeable with small working electrodes and the least noticeable when the electrodes are several times larger than the optode. This suggests that the O₂ rebound (FIG. 35, top) and an increasing difference between optode and electrode OCRs (FIG. 36) are contributed by O₂ diffusion along the electrode. Larger electrode size requires longer diffusion distance from the periphery of the chamber to the optode (distance w in FIG. 34). This further implies that O₂ concentration varies in the plane of the electrode and that caution must be exercised in quantitative measurements involving large changes in concentrations of O₂ or other substrates.

The preceding expected results demonstrate that mediated electron flux between mitochondria and the electrode can control the activity of ETC complexes. To make the amperometric data of FIGS. 34-36 meaningful in the context of the biological measurements of FIG. 33, electric currents should show quantitative correlation with the intrinsic mitochondrial activity and, more importantly, changes in such activity. To achieve this, the overall process must not be limited by either heterogeneous redox reactions or the mass transfer steps (k₁ and k₂-k₄ in FIG. 42, respectively).

FIG. 42 shows mass transfer schematics of mediated mitochondrial electrochemistry. An external mediator is utilized to facilitate electron transfer across the semi-permeable outer mitochondrial membrane (“OMM”), which precludes direct electron transfer between COX or endogenous CytC and the electrode. In this example, oxidized mediator (“Mₒₓ”) is reduced at the electrode, crosses OMM, and is oxidized by the endogenous CytC. Electron transfer from CytC to COX in the inner mitochondrial membrane (“IMM”) results in the reduction of oxygen to water. Changes in the overall catalytic turnover rate of complex IV (k₆) can be determined amperometrically, provided that all other steps are not rate limiting, including electron mediator reduction on the electrode (k₁), mediator diffusion in the solution and in the mitochondrial intermembrane space (k₂ and k₄, respectively), passive mediator transport across OMM (k₃), and bimolecular reduction of CytC (k₅).

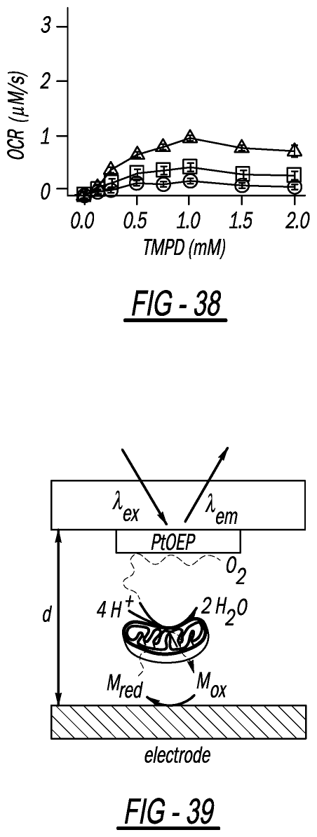

More specifically, FIGS. 37-40 illustrate electrochemically supported respiration in mitochondrial suspension per the diagram shown in FIG. 39. OCRs observed upon either chemical reduction of TMPD (FIG. 37) or TMPD reduced on the microfluidic electrode (FIG. 38) are shown across the range of TMPD concentrations. Respiration occurring in the presence of 4 mM sodium ascorbate as a reductant (FIG. 34) is followed using Clark electrode in 3 ml of stirred mitochondrial suspension. Respiration occurring upon electrochemical reduction of TMPD at −150 mV (FIG. 38) is followed using PtOEP optode. Referring to FIG. 41, a schematic diagram of microfluidic respiration shows all measurements being conducted using dilutions of common mitochondrial stock at 1× (circles), 2× (squares), and 4× (triangles) densities using both instruments on different days. The average protein concentrations are 0.17 mg/mL and 0.14 mg/mL for FIGS. 37 and 38, respectively, which correspond to the total amounts of protein of 0.34 mg and 0.50 μg used in polarographic and microfluidic chambers, respectively. All OCRs are shown as an increase over background O₂ reduction in the absence of mitochondria at corresponding TMPD concentrations. Moreover, separate controls are measured in polarographic and microfluidic conditions.

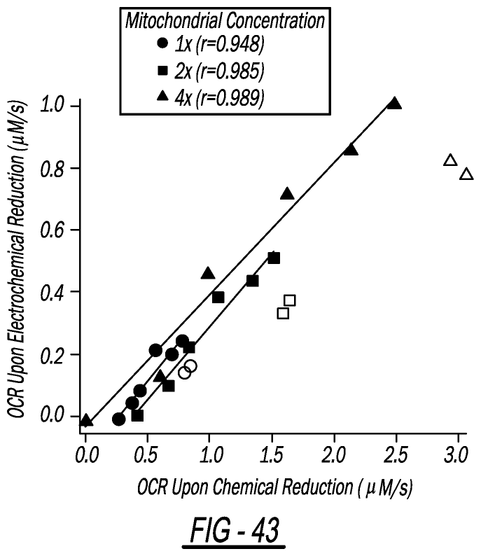

Pair-wise comparison between OCR observed upon electrochemical reduction and that using ascorbate as an electron donor at identical TMPD concentrations of ≤1 mM show linear correlation with the average Pearson's r=0.974±0.022 between three different densities of mitochondrial suspensions, with reference to FIG. 43. At higher TMPD concentrations, OCRs first plateau and then decline. Microfluidic OCRs measured upon reduction on the electrode reached maximal activity at lower TMPD concentrations than corresponding polarographic measurement using ascorbate as a reductant, leading to the loss of correlation at 1.5 mM TMPD, with reference to FIGS. 37, 38 and 43. Furthermore, pronounced background reduction of O₂ is observed at concentrations of TMPD above 1 mM, hindering measurements of dilute mitochondrial suspensions.

The last requirement for a direct correlation between the catalytic activity in the solution and the supporting electric current is small contribution of mass transfer into the overall rate limitation (k₂-k₄ in FIG. 42). Mass transfer is negligible when respiration is supported by homogenous reaction between TMPD and ascorbate in the traditional assays, which results in proportionality between the mitochondrial suspension density and OCR at each given TMPD concentration. This is an established protocol that can adequately report changes in the activity of COX in mitochondria.

In contrast, mass transfer of TMPD between the electrode and the endogenous mitochondrial CytC as seen in FIG. 39, may limit the overall turnover rate. Electrochemically driven respiration, per FIG. 38, show ˜2.5-fold lower OCR than that using ascorbate as a chemical reductant, illustrated in FIG. 37, for the same mitochondrial stock. All expected measurements reported in FIGS. 37 and 38 are performed using the same large stock of mitochondrial suspension in alternating order over multiple days.

Mitochondrial suspensions used herein are treated with an uncoupler (CCCP) for maximal COX turnover rates to exasperate any kinetic limitations associated with the mass transport of TMPD. Two observations indicate that mass transport is sufficient to support O₂ reduction in uncoupled mitochondria and, hence, under more physiological conditions where electron demand is lower. First, electrode-driven OCR remained proportional to the concentration of mitochondrial suspension at all TMPD concentrations. Second, maximal activity is observed at comparable, albeit not identical, TMPD concentrations. Together these results indicate that the overall reaction in the electrochemical assay (FIG. 38) is still controlled by the same rate laws as in the other method of FIG. 37, even if maximal OCR is somewhat limited by either heterogeneous reduction or the diffusion of the mediator.

Inherent variability of biological samples in traditional respirometry is offset by using activity ratios versus well-defined metabolic reference states. Therefore, the electrochemically driven metabolic assay also accurately reports changes in the activity of a given mitochondrial sample. It additionally detects variations in the intrinsic activity of ETC components at a constant suspension density rather than changes in concentrations of bimolecular reactants. For example, inhibition of COX by the chemiosmotic potential is a notable characteristic of the IMM (coupling) while changes in the bimolecular reaction rate between endogenous CytC and TMPD are not.

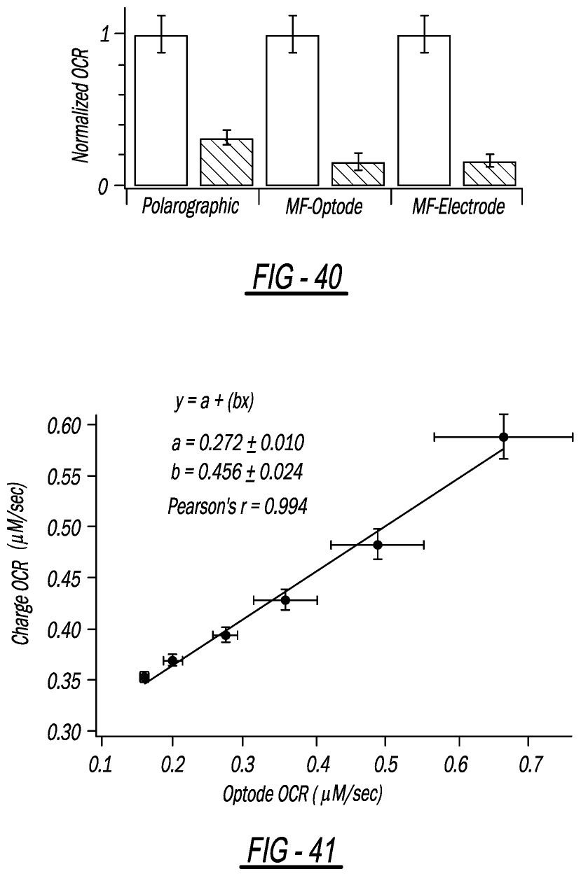

Referring now to FIG. 40, ratiometric assessment of the intrinsic activity of COX in the inner mitochondrial membrane is depicted. OCR of uncoupled mitochondria (solid bars) and its inhibition by 1 mM NaN₃ (hashed bars) are measured using a Clark electrode (left) or microfluidic electrochemistry with simultaneous optode (middle) and electrode (right) detection. All OCRs are normalized to the activity of uninhibited samples after subtraction of residual OCR (4 mM NaN₃). Samples contained 1 mM TMPD and polarographic measurements are performed in the presence of 8 mM Na ascorbate. Microfluidic measurements are performed under an applied potential of −250 mV on activated AuCi electrode. Moreover, samples contained 0.175 mg/mL and 0.094 mg/mL protein in polarographic and microfluidic measurements, respectively.

With reference to FIG. 40, partial inhibition of COX in uncoupled mitochondria is used here as a chemically reproducible model to test the ability of the heterogeneous electrochemical assay to report typical changes in the intrinsic activity of ETC complexes. NaN₃ is chosen as an inhibitor of COX over KCN due to its compatibility with an Au conductor layer, even though direct contact with the substrate of the modified electrode is limited. Initial polarographic titrations of NaN₃ in the presence of Na ascorbate show that 1 mM NaN₃ inhibits respiration to 32±4.5% of the control sample after subtraction of the residual activity observed in the presence of 4 mM NaN₃ (FIG. 40, left). A comparable 3-4 fold change in OCR would approximate changes observed during typical respiratory control ratio measurements in the presence of pyruvate and succinate, for example, although difference ratios have been reported for other substrates. Parallel microfluidic electrode-driven measurements show NaN₃-inhibited OCR of 16±3.7% and 16±2.4% when detected simultaneously by the optode (middle of FIG. 40) and the charge (right), respectively, after correction for residual activity. Both microfluidic detection methods yielded remarkably close values with smaller variability reported by the electrode than by the optode. A larger extent of inhibition observed in the electrode-driven assay is likely contributed by the differences in sample volumes between a Clark electrode (>1 ml) and microfluidics (<10 μl) that lead to large differences between sample handling protocols.

Next, FIG. 41 shows an expected correlation between oxygen consumption rates simultaneously determined from the transferred charge and fluorescence quenching. The plot shows a relationship between charge OCR and the optode where OCR is presented in FIG. 36. Pearson's r=0.994 exceeds the critical value of 0.707 for this sample (n=6, a=0.5).

Referring now to FIG. 43, a correlation of expected mitochondrial oxygen consumption rates is observed upon chemical and electrochemical reduction at various TMPD concentrations. Polarographic OCRs (horizontal axis) observed upon chemical reduction with ascorbate and microfluidic electrochemical OCRs (vertical axis) are obtained from the data shown in FIGS. 37 and 38. Only results obtained at TMPD concentrations of 1 mM and below (solid markers) were considered in linear correlation analysis, while TMPD concentrations of 1.5 mM and 2 mM (open markers) are not. The Pearson correlation coefficients r for each group are shown and the value for each of these groups is 0.707 (n=6, a=0.5).

Finally, the electrochemical probe of ETC metabolism is designed to examine changes in the intrinsic rate limitations of the particulate sample (organelle suspension) by providing mediated electron flux in excess of the activity of interest. In standalone applications and in tandem with respirometry, a primary advantage of this technique is the ability to make O₂ an optional reporter molecule which gives flexibility in experimental design. In this study, amperometric measurements are expected to consistently show smaller variability than simultaneous microfluidic optode measurements, as illustrated in FIGS. 34-36, 40 and 41. This offers intriguing possibilities, including tandem studies comparing upstream mediated electron supply versus electron sink into O₂, direct targeting of individual ETC complexes, and metabolic studies in anoxic conditions. One biomedically relevant example is the mechanisms ceramide-mediated mitochondrial damage that is proposed to involve either direct inhibition of CmpIII or an indirect inhibition upon permeabilization of OMM via Bax/BcI2 pore and ceramide channel formation leading to the loss of CytC. Another area of potential impact involves metabolic response under hypoxic or anoxic conditions, such as acute ischemia, oxidative stress, and under the conditions of an avascular tumor. In addition to the suppression of the detection induced O₂ depletion, the freedom to control the applied potential permits reversible electron transfers and paves the way to new differential measurement protocols when samples are not physically amenable to traditional chemical manipulations. Furthermore, by creating minimal environment that mimics cytosolic composition, the use of applied potential to control and manipulate functional state of mitochondria enables transient investigations in artificial respiration that cannot be afforded using depletable chemical cofactors, such as in FIGS. 32 and 33.

The present microfluidics instrument and method multiply these potential applications by reducing sample demand and creating a possibility for studies on scarce samples, including human biopsy tissues, primary cell cultures, and small animal models. A thousand-fold reduction in sample volume from 2-3 mL in conventional mitochondrial polarography to 4 μL or less in the present microfluidic respirometer advantageously allows use of more concentrated samples and boosts the output signal while keeping overall sample demand within attainable limits. Stationary sampling conditions, shown here for tandem respirometry, permit longer signal accumulation improving sensitivity over differential polarographic measurements in flow sampling conditions as long as detection methods do not consume significant amounts of O₂. The simple suspension loading approach used herein can be improved by entrapment of organelles in the chamber, curbing sample overhead of the loading capillaries, eliminating the need for sample replacement between measurements, and permitting sampling of the same specimen under multiple experimental conditions. The present studies on microfluidic respirometry of adherent cells under similar conditions offer an alternative approach where selective permeabilization of the cellular wall could, in principle, provide access of mediators to mitochondria without their isolation.

Another major advantage of the present microfluidics instrument and method are the suppression of the mass transfer effects when the sample is confined within the diffusion limit of the electrode. For a sample thickness of <150 μm used here, effects of mass transfer are observed only for the first 10 seconds after the potential step while the dynamic equilibrium is established. As long as changes in the sample composition remain relatively small during sampling, the effect of mass transfer on the minutes time scale is negligible. Biological relevance of this constraint is supported by a low reported variability of tissue-dependent O₂ concentration over time, whereby the partial mitochondrial inhibition model shows that mass transfer does not hinder measurements of relative activities in mitochondrial suspensions as shown in FIG. 40. Should the mass transfer impose an overall rate limit under these conditions, subsequent inhibition of COX by NaN₃ would have either no effect on the observed OCR or partially shift rate limit to COX—in either case this would yield a smaller apparent inhibition than that observed using chemical reduction. This is contrary to the expected results presented in FIG. 40 even for the worst-case scenario of the most active (uncoupled) mitochondrial samples.

The present work presents several practical simplifications that should be considered in translating current results to physiological conditions. Isolation and storage protocols used herein are designed to reduce biological variability associated with multiple mitochondrial isolations and to provide large amount of chemically uniform suspension sample needed for comparative studies. Although freezing of mitochondria typically increases mitochondrial permeability of the membranes, it does not cause solubilization of COX, thus preserving the most distinct characteristics of mitochondria as a particulate catalyst of O₂ reduction. This is supported by the lack of respiratory activity in the absence of TMPD. Similarly, possible loss of matrix enzymes is not expected to affect activity of COX herein, although this cannot be ignored in the studies involving typical mitochondrial substrates. Lastly, mitochondrial respiration is sensitive to temperature.

In conclusion, sensitivity of respiration, catalyzed by COX in the IMM, to the applied potential demonstrates that mediated electrochemistry is an effective analytical tool for quantitative studies on ETC beyond existing methods that track O₂ consumption. Tandem assessment using fluorometric respirometry and simultaneous amperometry shows good correlation between charge transferred at the electrode and the resulting O₂ reduction both in inorganic model and TMPD-mediated catalysis by COX. Large, bio-compatible electrodes can sustain near-maximal turnover of the components of the ETC with the support of small molecule mediators. Further, high conductivity of the Au layer combined with resilience of modified AuFS or AuCi electrodes to protein fouling results on activities that are comparable to established mitochondrial assays that utilize ascorbate as a reductant. In addition to >500-fold reduction in sample demand versus conventional respirometry, microfluidics provides significant method-specific advantage by limiting diffusion distance of mediators and substrates, thus ensuring relative sample homogeneity.

Changes in the redox state of the sample, induced by the applied potential pulse, propagate across the thin layer on the seconds times scale, making diffusion mass transfer along the normal to the electrode insignificant in most biological applications. Mass transfers in the plane of the electrode, however, may affect to the experimental observations and must be considered in analysis, but such effects can be minimized by limiting reaction-induced variations in the sample composition. Moreover, employment of differential sampling protocols, afforded by the reversible potential steps and the resulting redox transitions in the mediator medium, can improve sensitivity and alleviate sample depletion. Unlimited and controllable supply of the electrons opens the door to transient sample control and novel studies that mimic native metabolic pathways.

The present electrode feature advantageously directly measures metabolism of the specimen via an electron charge transfer and without the need for oxygen sensing, although an oxygen sensor can optionally still be located in the specimen chamber. This direct path provides a more precise measurement. Furthermore, the electrodes can be remotely energized, de-energized or have their current changed without the need to contact or physically disrupt the specimen and/or disassemble the instrument.

While various embodiments have been disclosed, it should be appreciated that other variations are possible. For example, a different quantity and shape of the specimen and solution channels may be employed although certain benefits may not be realized. Furthermore, the exterior shapes, interior passageway paths, and/or port arrangements of the manifold may be differently configured although some of the advantages of the present components may not be obtained. While it has been disclosed to use certain specimens, different specimens can be used, although the present instrument and method may perform differently. It should also be appreciated that the terms “top,” “bottom,” “upper,” “lower,” “back,” “side,” “end” and other such phrases are merely relative terms which may vary if the parts are inverted or differently oriented. The method steps may be performed in any order or even simultaneously for some operations. The features of any embodiment may be interchanged with any of the other embodiments, and the claims may be multiply dependent in any combination. Therefore, other variations may fall within the scope and spirit of the present invention.

The invention claimed is:

1. A microfluidic measurement instrument comprising:
a manifold including an inlet port and an outlet port with at least one passageway therebetween;
a housing including a channel and passageways coupled to the at least one passageway of the manifold;
a plate located against the housing and acting with the housing to create a specimen chamber within the channel; and
the housing comprising an optically transparent material of low oxygen permeability at the channel.

2. The instrument of claim 1, further comprising an optical fiber extending through the manifold or below the chamber, and a sensor attached to the housing adjacent to the channel, the sensor being coupled to the optical fiber.

3. The instrument of claim 1, further comprising a base located adjacent a side of the plate opposite the housing which is directly positioned against the manifold, the base removably securing the plate and the housing to the manifold.

4. The instrument of claim 1, wherein the manifold and the housing are polymeric and the plate is glass.

5. The instrument of claim 1, wherein the housing is additively manufactured to create smooth surfaces defining walls of the channel, the channel being laterally elongated.

6. The instrument of claim 1, further comprising:
a base secures the plate and the housing to the manifold;
a spring is attached to the base;
pins upstand from the base for alignment with slots in the housing; and
the manifold includes flat peripheral surfaces through which the ports are positioned.

7. The instrument of claim 1, further comprising a biological specimen located in the specimen chamber and a liquid solution flowing into the inlet port of the manifold, through the passageways of the housing, along the channel of the housing, past the biological specimen in the specimen chamber, and out of the outlet port of the manifold, in a continuous flowing manner without oxygen entry through the housing or the plate into the specimen chamber.

8. The instrument of claim 1, further comprising:
an arcuately shaped ring seal;
a base including an internal wall surface;
the ring seal being compressed between the internal wall surface of the base and an outer peripheral surface of the housing, the housing being an insert at least partially internal to the base;
the base and the housing being mounted on top of the plate which is glass; and
the base, housing and plate being of an open-shell configuration configured to allow for placement of adherent cell specimens within a liquid media in the specimen chamber prior to insertion of a solution through the ports and the channel.

9. The instrument of claim 1, wherein there are multiples of the channel in the housing, the channels being laterally elongated.

10. The instrument of claim 1, further comprising a washing fluid flowing through the ports and the channel between insertion of different liquid solutions flowing through the ports and the channel, without removing a biological specimen in the specimen chamber between the washing and the solution flowing.

11. The instrument of claim 1, further comprising electrodes coupled to at least of one: the passageways and the channel.

12. The instrument of claim 1, further comprising electrodes measuring both a reduction of mediators on at least one of the electrodes and a reduction of oxygen in an inner mitochondrial membrane.

13. The instrument of claim 1, further comprising at least one electrode coupled to at least one of the manifold, the housing and the plate, the at least one electrode continuously sensing an oxygen-independent, electrochemical assay while targeting components of electron transport chains while keeping specimen samples catalytically active for at least two days in the specimen chamber.

14. The instrument of claim 1, further comprising:
a potentiostat electrically connected to a conductor located within the channel;
a first electrode located in the specimen chamber and connected to the conductor;
an oxygen sensor located in the specimen chamber; and
at least a second electrode mounted to the manifold or the housing and coupled to at least one of the passageways, the electrodes being spaced apart from each other.

15. A microfluidic measurement instrument comprising:
a housing including a laterally elongated channel, and offset angled inlet and outlet passageways located at ends of the channel;
a glass plate located against the housing and acting with the housing to create a specimen chamber within the channel;
the housing comprising an optically transparent and polymeric material of low oxygen permeability at the channel;
an optical fiber; and
a sensor coupled to the optical fiber, and the sensor being located adjacent to the channel.

16. The instrument of claim 15, wherein a depth of the channel in the housing is 70-150 μm.

17. The instrument of claim 15, further comprising:
a manifold including an inlet port and an outlet port with passageways therebetween, the passageways of the housing being fluidically coupled to the passageways of the manifold; and
a base located adjacent a side of the plate opposite the housing which is directly positioned against the manifold, the base removably securing the plate and the housing to the manifold.

18. The instrument of claim 15, wherein the material of the housing is three-dimensionally printable material configured to create smooth surfaces defining walls of the channel.

19. The instrument of claim 15, further comprising a biological specimen located in the specimen chamber and a liquid solution flowing into the inlet passageway of the housing, along the channel of the housing, past the biological specimen in the specimen chamber, and out of an outlet passageway of the housing, in a continuous flowing manner without oxygen entry through the housing or the plate into the specimen chamber.

20. The instrument of claim 15, further comprising:
an arcuately shaped ring seal;
a base including an internal wall surface;
the ring seal being compressed between the internal wall surface of the base and an outer peripheral surface of the housing, the housing being an insert at least partially internal to the base;
the base and the housing being mounted on top of the plate which is glass; and
the base, housing and plate being of an open-shell configuration configured to allow for placement of adherent cell specimens within a liquid media in the specimen chamber prior to insertion of a solution into the channel.

21. The instrument of claim 15, further comprising at least one electrode coupled to at least one of the passageways or the channel, the at least one electrode continuously sensing an oxygen-independent, electrochemical assay while targeting components of electron transport chains while keeping specimen samples catalytically active in the specimen chamber.

22. The instrument of claim 15, further comprising:
a first electrode located in the specimen chamber;
the sensor is an oxygen sensor located in the specimen chamber; and
at least a second electrode coupled to at least one of the passageways, the electrodes being spaced apart from each other.

23. A microfluidic measurement instrument comprising:
a manifold including an inlet port and an outlet port with at least one passageway therebetween;
a housing including a channel and passageways coupled to the at least one passageway of the manifold;
a plate located against the housing and acting with the housing to create a specimen chamber within the channel;
a biological specimen located in the specimen chamber and a liquid solution flowing into the inlet port of the manifold, through the passageways of the housing, along the channel of the housing, past the biological specimen in the specimen chamber, and out of the outlet port of the manifold, in a continuous flowing manner without oxygen entry through the housing or the plate into the specimen chamber;
a first electrode located in the specimen chamber;
at least a second electrode coupled to at least one of the passageways, the electrodes being spaced apart from each other; and
the electrodes directly measuring metabolism of the specimen in the specimen chamber through an electron charge transfer without the need to measure oxygen in the specimen.

24. The instrument of claim 23, further comprising:
a potentiostat electrically connected to a conductor located within the channel;
the first electrode being connected to the conductor;
the housing comprising an optically transparent material of low oxygen permeability at the channel; and
an oxygen sensor located in the specimen chamber.

25. The instrument of claim 23, wherein the electrodes simultaneously assess flurometric respirometry and amperometry of the specimen.

26. The instrument of claim 23, wherein at least one of the electrodes cause mediator molecules to cross an outer mitochondrial membrane of the specimen.

27. A method of manufacturing an instrument, the method comprising:
(a) additively layering an optically transparent and polymeric material of low oxygen permeability to create a smooth walled and elongated specimen chamber;
(b) creating fluid flow passageways to and from the specimen chamber;
(c) attaching a sensor or electrode internal to the specimen chamber; and
(d) enclosing the specimen chamber to allow use of the instrument in performing microfluidic respirometry of metabolic functions in biological samples with a continuous flow of solution to a specimen in the specimen chamber without oxygen entry into the specimen chamber through a chamber surface.

28. The method of claim 27, further comprising:
attaching a flat glass plate to a housing to define a surface of the specimen chamber;
manufacturing a manifold with inlet and outlet ports, and passageways connecting the ports to the passageways of the housing; and
coupling the manifold to the housing.

29. The method of claim 27, wherein the instrument is configured to allow at least one of:
(a) inserting a washing fluid flowing through the passageways and the specimen chamber between insertion of different liquid solutions flowing through the passageways and the specimen chamber, without removing a biological specimen in the specimen chamber between the washing and the solution flowing;
(b) changing or supplementing a composition or volume of the liquid solutions flowing through the passageways and the specimen chamber at any time during the solution flowing process.

30. The method of claim 27, further comprising inserting biological suspension cells in the specimen chamber.
